(19) United States
(12) Patent Application Publication
(10) Pub. No.: US 2025/0224285 A1
(43) Pub. Date: Jul. 10, 2025

(54) MEASUREMENT DEVICE AND LOAD DETECTION SYSTEM

(71) Applicant: Panasonic Intellectual Property Management Co., Ltd., Osaka (JP)

(72) Inventor: Masaki TAMARU, Kyoto (JP)

(21) Appl. No.: 19/091,236

(22) Filed: Mar. 26, 2025

Related U.S. Application Data
(63) Continuation of application No. PCT/JP2023/024093, filed on Jun. 28, 2023.

(30) Foreign Application Priority Data
Oct. 7, 2022 (JP) 2022-162713

(51) Int. Cl. G01L 1/14

(52) U.S. Cl. CPC G01L 1/144

(57) ABSTRACT

A measurement device includes: a switchover part configured to switch application and non-application of a voltage to a voltage applier; a measurer configured to measure a current in a supply line of the voltage applier; and a controller configured to control the switchover part and the measurer to measure the current that changes to be saturated in the supply line. The controller sets a plurality of measurement periods different from each other, starts application of the voltage in synchronization with start of each of the measurement periods, determines whether or not the current measured by the measurer in each of the measurement periods has become saturated, and acquires a measurement result of the current with respect to the measurement period for which it has been determined that the current has become saturated.

### CROSS REFERENCE TO RELATED APPLICATION

This application is a continuation of International Application No. PCT/JP2023/024093 filed on Jun. 28, 2023, entitled “MEASUREMENT DEVICE AND LOAD DETECTION SYSTEM”, which claims priority under 35 U.S.C. Section 119 of Japanese Patent Application No. 2022-162713 filed on Oct. 7, 2022, entitled “MEASUREMENT DEVICE AND LOAD DETECTION SYSTEM”. The disclosures of the above applications are incorporated herein by reference.

### BACKGROUND OF THE INVENTION

### Field of the Invention

The present invention relates to a measurement device that measures an electric quantity that changes to be saturated in association with application of a voltage, and a load detection system using the measurement device.

### Description of Related Art

To date, a capacitance-type load sensor in which the capacitance in an element part changes in accordance with a load has been known. In a load sensor of this type, for example, based on change in a voltage when the voltage is applied to an element part, the capacitance in the element part is detected. A load detection device using a load sensor of this type is described in Japanese Laid-Open Patent Publication No. 2021-81209, for example.

In addition, Japanese Laid-Open Patent Publication No. 2005-91021 describes a current measurement device that can measure the current flowing in a circuit, in a measurement range from a low current value to a high current value. In this device, the current flowing in a measurement target wire is measured by using two sensors, i.e., a high range sensor and a low range sensor.

In a capacitance-type load sensor, from the electric charge amount accumulated in an element part when a voltage has been applied to the element part, the capacitance in the element part can be detected. In this case, for example, by measuring the current that flows in the element part from when a voltage has been applied to the element part until the accumulated electric charge is saturated, the electric charge amount accumulated in the element part can be calculated.

On the other hand, the capacitance in an element part changes in accordance with the range (dynamic range) of the load that should be detected. Therefore, the period until completion of accumulation of the electric charge in the element part changes in accordance with the load applied to the element part. Therefore, when the current flowing in an element part is measured as described above, the period necessary for current measurement changes in accordance with the load.

In this case, it is also possible to use a method in which a measurement period necessary when the maximum load is applied to the element part is uniformly applied to the entire load in the dynamic range. However, in this method, even when the load applied to the element part is small, a long measurement period for a high load is applied, which results in a problem that the load cannot be efficiently detected. In Japanese Laid-Open Patent Publication No. 2005-91021 above, this problem is not particularly taken into consideration.

### SUMMARY OF THE INVENTION

A first aspect of the present invention relates to a measurement device. The measurement device according to this aspect includes: a switchover part configured to switch application and non-application of a voltage to an electric circuit; a measurer configured to measure an electric quantity in a predetermined portion in the electric circuit; and a controller configured to control the switchover part and the measurer to measure the electric quantity that changes to be saturated in the predetermined portion. The controller sets a plurality of measurement periods different from each other, starts application of the voltage in synchronization with start of each of the measurement periods, determines whether or not the electric quantity measured by the measurer in each of the measurement periods has become saturated, and acquires a measurement result of the electric quantity with respect to the measurement period for which it has been determined that the electric quantity has become saturated.

In the measurement device according to the present aspect, among a plurality of measurement periods different from each other, with respect to the measurement period for which it has been determined that the electric quantity serving as the measurement target has become saturated, a measurement result of the electric quantity is acquired. Therefore, even when the period until the electric quantity serving as the measurement target becomes saturated may change, the measurement period for the electric quantity can be appropriately set, and a highly accurate measurement result can be efficiently acquired.

A second aspect of the present invention relates to a load detection system. The load detection system according to this aspect includes: a load sensor including an element part in which capacitance changes in accordance with a load; a voltage applier including the measurement device according to the first aspect and configured to apply a voltage to the element part; and a signal processor configured to acquire the capacitance in the element part from a measurement result obtained by the measurement device. The measurement device applies the voltage to the element part through the switchover part, measures an electric quantity in a predetermined portion of the voltage applier through the measurer, and outputs a measurement result of the electric quantity acquired by the controller, to the signal processor.

In the load detection system according to the present aspect, since the measurement device according to the first aspect is used, even when the capacitance in the element part changes in accordance with the load, a measurement period according to the capacitance can be set. Therefore, the electric quantity according to the capacitance can be efficiently and accurately measured, and the load in the element part can be accurately detected.

The effects and the significance of the present invention will be further clarified by the description of the embodiment below. However, the embodiment below is merely an example for implementing the present invention. The present invention is not limited to the description of the embodiment below in any way.

### BRIEF DESCRIPTION OF THE DRAWINGS

FIG. 1A is a perspective view schematically showing a base member and electrically-conductive elastic bodies set on the upper face of the base member according to an embodiment;

FIG. 1B is a perspective view schematically showing a state where conductor wires are set on the structure in FIG. 1A according to the embodiment;

FIG. 2A is a perspective view schematically showing a state where threads are set on the structure in FIG. 1B according to the embodiment;

FIG. 2B is a perspective view schematically showing a state where a base member is set on the structure in FIG. 2A according to the embodiment;

FIG. 3A and FIG. 3B each schematically show a cross section of a load sensor according to the embodiment;

FIG. 4 is a plan view schematically showing a configuration of the inside of the load sensor according to the embodiment;

FIG. 5 is a block diagram showing a configuration of a load detection system according to the embodiment;

FIG. 6 is a circuit diagram showing a configuration of a voltage applier according to the embodiment;

FIG. 7 is a time chart showing gate signals outputted from a controller according to the embodiment;

FIG. 8 shows an operation state of the voltage applier when a voltage is applied to an element part serving as the measurement target according to the embodiment;

FIG. 9 shows an operation state of the voltage applier during discharging according to the embodiment;

FIG. 10A to FIG. 10D are each a graph showing a relationship between a measurement period and a current measured by a measurer according to the embodiment;

FIG. 11 is a graph showing a simulation result of a relationship, when the capacitance in an element part serving as the measurement target has a predetermined value, between a cycle ratio and an average current ratio according to the embodiment;

FIG. 12 is a flowchart showing a process of acquiring a measurement result of the current with respect to an element part serving as the measurement target according to the embodiment;

FIG. 13A and FIG. 13B are each a flowchart showing a process of determining whether or not the current has become saturated in a measurement period according to the embodiment;

FIG. 14A and FIG. 14B each describe a method of determining whether or not the current has become saturated in a measurement period according to Modification 1;

FIG. 15 shows a configuration of a measurement device according to Modification 2;

FIG. 16 shows the flow of the current when electric charge accumulated in an element part serving as the measurement target is discharged according to Modification 2;

FIG. 17 is a graph showing a simulation result of a relationship, when the capacitance in an element part serving as the measurement target has a predetermined value, between the cycle ratio and the average current ratio according to Modification 2;

FIG. 18 shows a configuration of the measurement device according to Modification 3;

FIG. 19A to FIG. 19D are each a graph showing a relationship between a measurement period and a voltage measured by the measurer according to Modification 3;

FIG. 20 is a flowchart showing a process of acquiring a measurement result of the voltage with respect to an element part serving as the measurement target according to Modification 3; and

FIG. 21A and FIG. 21B are each a flowchart showing a process of determining whether or not the voltage has become saturated in a measurement period according to Modification 3.

It is noted that the drawings are solely for description and do not limit the scope of the present invention in any way.

### DETAILED DESCRIPTION

A load detection system according to the present invention is applicable to a management system or the like that performs processing in accordance with an applied load. Examples of the management system include a stock management system, a driver monitoring system, a coaching management system, a security management system, and a caregiving/nursing management system.

In the stock management system, for example, by a load sensor provided to a stock shelf, the load of a placed commodity is detected, and the kinds of commodities and the number of commodities present on the stock shelf are detected. Accordingly, in a store, a factory, a warehouse, and the like, the commodities can be efficiently managed, and manpower saving can be realized. In addition, by a load sensor provided in a refrigerator, the load of food in the refrigerator is detected, and the kinds of the food and the quantity and amount of the food in the refrigerator are detected. Accordingly, a menu that uses food in a refrigerator can be automatically proposed.

In the driver monitoring system, by a load sensor provided to a steering device, the distribution of a load (e.g., gripping force, grip position, tread force) applied to the steering device by a driver is monitored, for example. In addition, by a load sensor provided to a vehicle-mounted seat, the distribution of a load (e.g., the position of the center of gravity) applied to the vehicle-mounted seat by the driver in a seated state is monitored. Accordingly, the driving state (sleepiness, mental state, and the like) of the driver can be fed back.

In the coaching management system, for example, by a load sensor provided to the bottom of a shoe, the load distribution at a sole is monitored. Accordingly, correction or guidance to an appropriate walking state or running state can be realized.

In the security management system, for example, by a load sensor provided to a floor, the load distribution is detected when a person passes, and the body weight, stride, passing speed, shoe sole pattern, and the like are detected. Accordingly, the person who has passed can be identified by checking these pieces of detection information against data.

In the caregiving/nursing management system, for example, by load sensors provided to bedclothes and a toilet seat, the distributions of loads applied by a human body to the bedclothes and the toilet seat are monitored. Accordingly, at the positions of the bedclothes and the toilet seat, what action the person is going to take is estimated, whereby tumbling or falling can be prevented.

The load detection system of the embodiment below is applied to a management system as described above, for example. The load detection system of the embodiment below includes: a load sensor for detecting a load; and a detection unit combined with the load sensor. The load sensor of the embodiment below is a capacitance-type load sensor. Such a load sensor may be referred to as a “capacitance-type pressure-sensitive sensor element”, a “capacitive pressure detection sensor element”, a “pressure-sensitive switch element”, or the like. The embodiment below is an example of embodiments of the present invention, and the present invention is not limited to the embodiment below in any way.

Hereinafter, an embodiment of the present invention will be described with reference to the drawings. For convenience, X-, Y-, and Z-axes orthogonal to each other are indicated in the drawings. The Z-axis direction is the height direction of a load sensor 1.

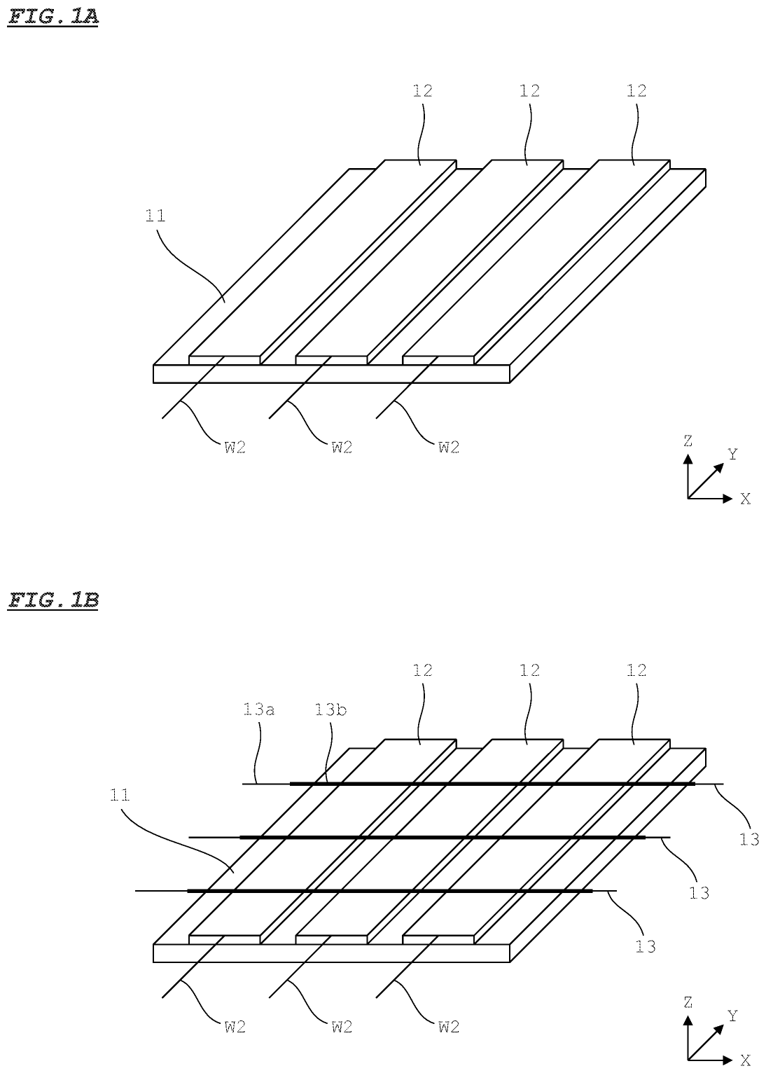

With reference to FIG. 1A to FIG. 4, the load sensor 1 will be described.

FIG. 1A is a perspective view schematically showing a base member 11 and electrically-conductive elastic bodies 12 set on the upper face (the face on the Z-axis positive side) of the base member 11.

The base member 11 is an insulative flat-plate-shaped member having elasticity. The base member 11 has a rectangular shape in a plan view. The thickness of the base member 11 is constant. The thickness of the base member 11 is 0.01 mm to 2 mm, for example. When the thickness of the base member 11 is small, the base member 11 may be referred to as a sheet member or a film member. The base member 11 is formed from a non-electrically-conductive resin material or a non-electrically-conductive rubber material.

The resin material used in the base member 11 is a resin material of at least one type selected from the group consisting of a styrene-based resin, a silicone-based resin (e.g., polydimethylpolysiloxane (PDMS)), an acrylic resin, a rotaxane-based resin, a urethane-based resin, and the like, for example. The rubber material used in the base member 11 is a rubber material of at least one type selected from the group consisting of silicone rubber, isoprene rubber, butadiene rubber, styrene-butadiene rubber, chloroprene rubber, nitrile rubber, polyisobutylene, ethylene-propylene rubber, chlorosulfonated polyethylene, acrylic rubber, fluororubber, epichlorohydrin rubber, urethane rubber, natural rubber, and the like, for example.

The electrically-conductive elastic bodies 12 are disposed on the upper face (the face on the Z-axis positive side) of the base member 11. In FIG. 1A, three electrically-conductive elastic bodies 12 are disposed on the upper face of the base member 11. The electrically-conductive elastic bodies 12 are each an electrically-conductive member having elasticity. Each electrically-conductive elastic body 12 has a band-like shape that is long in the Y-axis direction. The three electrically-conductive elastic bodies 12 are disposed so as to be arranged with a predetermined interval therebetween in the X-axis direction. At an end portion on the Y-axis negative side of each electrically-conductive elastic body 12, a wiring cable W2 electrically connected to the electrically-conductive elastic body 12 is set.

Each electrically-conductive elastic body 12 is formed on the upper face of the base member 11 by a printing method such as screen printing, gravure printing, flexographic printing, offset printing, or gravure offset printing. With these printing methods, the electrically-conductive elastic body 12 can be formed so as to have a thickness of about 0.001 mm to 0.5 mm on the upper face of the base member 11.

Each electrically-conductive elastic body 12 is formed from a resin material and an electrically-conductive filler dispersed therein, or from a rubber material and an electrically-conductive filler dispersed therein.

Similar to the resin material used in the base member 11 described above, the resin material used in the electrically-conductive elastic body 12 is a resin material of at least one type selected from the group consisting of a styrene-based resin, a silicone-based resin (e.g., polydimethylpolysiloxane (PDMS)), an acrylic resin, a rotaxane-based resin, a urethane-based resin, and the like, for example.

Similar to the rubber material used in the base member 11 described above, the rubber material used in the electrically-conductive elastic body 12 is a rubber material of at least one type selected from the group consisting of silicone rubber, isoprene rubber, butadiene rubber, styrene-butadiene rubber, chloroprene rubber, nitrile rubber, polyisobutylene, ethylene-propylene rubber, chlorosulfonated polyethylene, acrylic rubber, fluororubber, epichlorohydrin rubber, urethane rubber, natural rubber, and the like, for example.

The electrically-conductive filler used in the electrically-conductive elastic body 12 is a material of at least one type selected from the group consisting of: metal materials such as Au (gold), Ag (silver), Cu (copper), C (carbon), Zno (zinc oxide), In₂O₃ (indium oxide (III)), and SnO₂ (tin oxide (IV)); electrically-conductive macromolecule materials such as PEDOT: PSS (i.e., a complex composed of poly(3,4-ethylenedioxythiophene)(PEDOT) and polystyrene sulfonate (PSS)); and electrically-conductive fibers such as a metal-coated organic matter fiber and a metal wire (fiber state), for example.

FIG. 1B is a perspective view schematically showing a state where conductor wires 13 are set on the structure in FIG. 1A.

Each conductor wire 13 is a linear-shaped member, and is disposed so as to be superposed on the upper faces of the electrically-conductive elastic bodies 12 shown in FIG. 1A. In the present embodiment, three conductor wires 13 are disposed so as to be superposed on the upper faces of the three electrically-conductive elastic bodies 12. The three conductor wires 13 are disposed so as to be arranged with a predetermined interval therebetween along the longitudinal direction (the Y-axis direction) of the electrically-conductive elastic bodies 12 so as to cross the electrically-conductive elastic bodies 12. Each conductor wire 13 is disposed, extending in the X-axis direction, so as to extend across the three electrically-conductive elastic bodies 12.

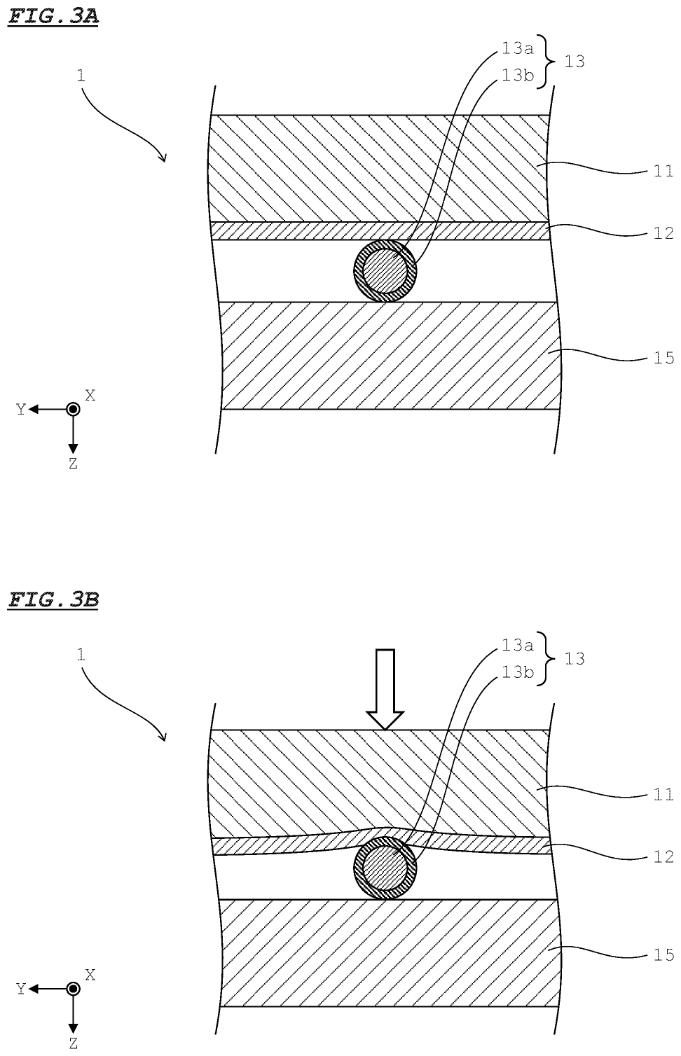

The conductor wire 13 is a covered copper wire, for example. The conductor wire 13 is composed of an electrically-conductive member 13a having a linear shape, and a dielectric body 13b formed on the surface of the electrically-conductive member 13a. The configuration of the conductor wire 13 will be described later with reference to FIGS. 3A, 3B.

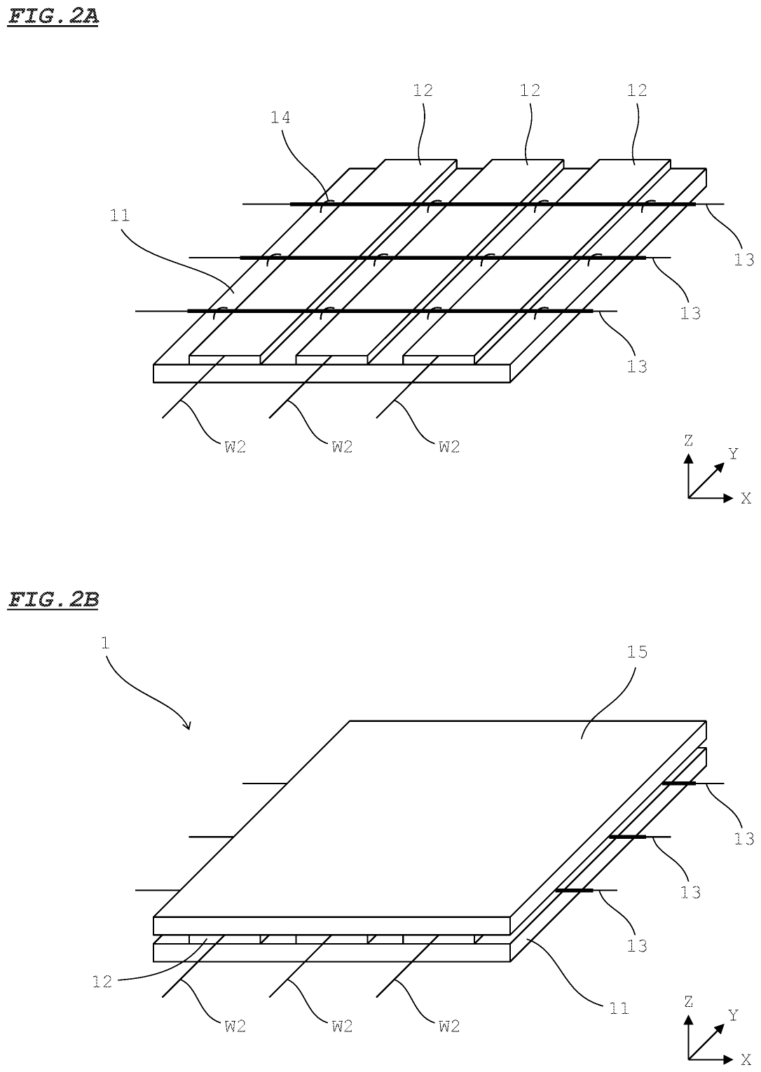

FIG. 2A is a perspective view schematically showing a state where threads 14 are set on the structure in FIG. 1B.

After the conductor wires 13 are disposed as shown in FIG. 1B, each conductor wire 13 is connected to the base member 11 by threads 14 so as to be able to move in the longitudinal direction (the X-axis direction) of the conductor wire 13. In the example shown in FIG. 2A, twelve threads 14 connect the conductor wires 13 to the base member 11 at positions other than the positions where the electrically-conductive elastic bodies 12 and the conductor wires 13 overlap each other. Each thread 14 is implemented by a chemical fiber, a natural fiber, a mixed fiber of the chemical fiber and the natural fiber, or the like.

FIG. 2B is a perspective view schematically showing a state where a base member 15 is set on the structure in FIG. 2A. The base member 15 is set from above (the Z-axis positive side) the structure shown in FIG. 2A. The base member 15 is an insulative member. The material of the base member 15 is a resin material of at least one type selected from the group consisting of polyethylene terephthalate, polycarbonate, polyimide, and the like, for example. The base member 15 may be formed from the same material as that of the base member 11. The base member 15 has a flat plate shape parallel to an X-Y plane and has the same size and shape as those of the base member 11 in a plan view. The thickness in the Z-axis direction of the base member 15 is 0.01 mm to 2 mm, for example.

The outer peripheral four sides of the base member 15 are connected to the outer peripheral four sides of the base member 11 with a silicone rubber-based adhesive, a thread, or the like. Accordingly, the base member 15 is fixed to the base member 11. The conductor wires 13 are sandwiched by the electrically-conductive elastic bodies 12 and the base member 15. Accordingly, the load sensor 1 is completed as shown in FIG. 2B. The load sensor 1 can be used in a state of having been flipped upside down from the state shown in FIG. 2B.

FIG. 3A and FIG. 3B each schematically show a cross section of the load sensor 1 along a plane parallel to a Y-Z plane at the center position in the X-axis direction of the electrically-conductive elastic body 12. FIG. 3A shows a state where no load is applied, and FIG. 3B shows a state where a load is applied.

As shown in FIGS. 3A, 3B, the conductor wire 13 is composed of an electrically-conductive member 13a and a dielectric body 13b formed on the electrically-conductive member 13a. The electrically-conductive member 13a is a member that is electrically conductive and that has a linear shape. The dielectric body 13b covers the surface of the electrically-conductive member 13a. The electrically-conductive member 13a is formed from copper, for example. The diameter of the electrically-conductive member 13a is about 60 μm, for example.

The dielectric body 13b has an electric insulation property, and is formed from a resin material, a ceramic material, a metal oxide material, or the like, for example. The dielectric body 13b may be a resin material of at least one type selected from the group consisting of a polypropylene resin, a polyester resin (e.g., polyethylene terephthalate resin), a polyimide resin, a polyphenylene sulfide resin, a polyvinyl formal resin, a polyurethane resin, a polyamide imide resin, a polyamide resin, and the like. Alternatively, the dielectric body 13b may be a metal oxide material of at least one type selected from the group consisting of Al₂O₃, Ta₂O₅, and the like. The dielectric body 13b is formed at least in the range where the conductor wire 13 overlaps the electrically-conductive elastic body 12.

As shown in FIG. 3A, when no load is applied, the force applied between the electrically-conductive elastic body 12 and the conductor wire 13, and the force applied between the base member 15 and the conductor wire 13 are approximately zero. From this state, as shown in FIG. 3B, when a load is applied to the face on the Z-axis negative side of the base member 11, the electrically-conductive elastic body 12 and the base member 11 are deformed by the conductor wire 13.

As shown in FIG. 3B, due to the application of a load, the conductor wire 13 is brought close to the electrically-conductive elastic body 12 so as to be wrapped by the electrically-conductive elastic body 12. In association with this, the contact area between the conductor wire 13 and the electrically-conductive elastic body 12 increases. Accordingly, the capacitance between the electrically-conductive member 13a and the electrically-conductive elastic body 12 changes. The capacitance between the electrically-conductive member 13a and the electrically-conductive elastic body 12 is detected, whereby the load applied to this region is acquired.

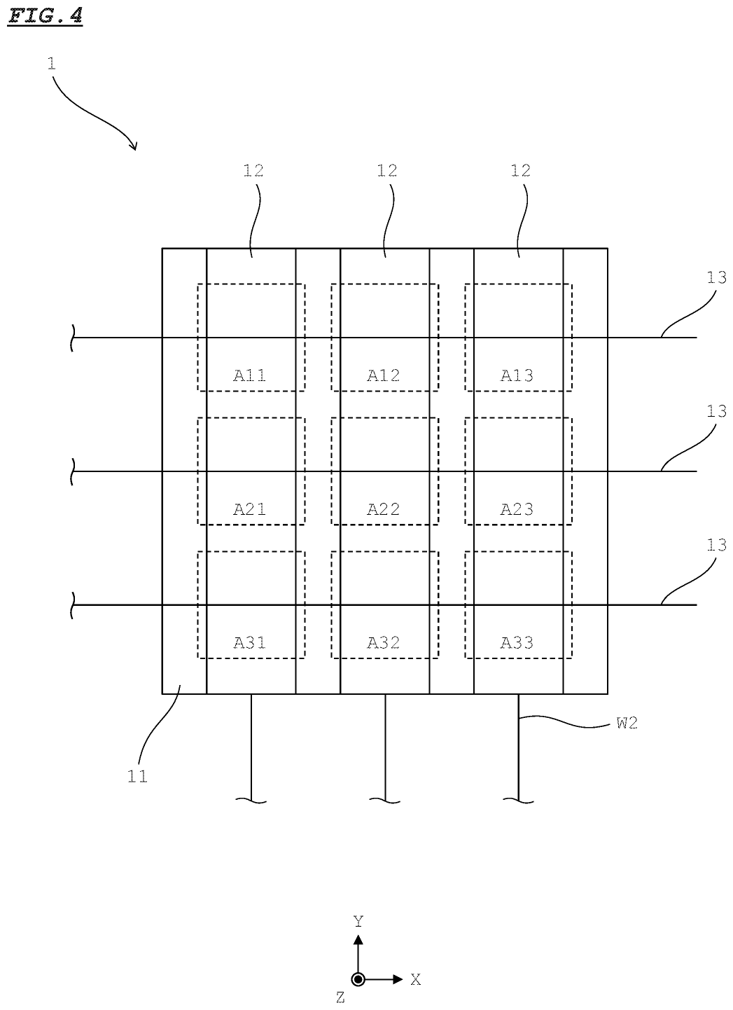

FIG. 4 is a plan view schematically showing a configuration of the inside of the load sensor 1. In FIG. 4, the threads 14 and the base member 15 are not shown for convenience.

As shown in FIG. 4, element parts A11, A12, A13, A21, A22, A23, A31, A32, A33 in which the capacitance changes in accordance with a load are formed at positions where the three electrically-conductive elastic bodies 12 and the three conductor wires 13 cross each other. Each element part includes an electrically-conductive elastic body 12 and a conductor wire 13 in the vicinity of the intersection between the electrically-conductive elastic body 12 and the conductor wire 13.

In each element part, the conductor wire 13 forms one pole (e.g., positive pole) for capacitance and the electrically-conductive elastic body 12 forms the other pole (e.g., negative pole) for capacitance. That is, the electrically-conductive member 13a (see FIGS. 3A, 3B) in the conductor wire 13 forms one electrode of the load sensor 1 (capacitance-type load sensor), the electrically-conductive elastic body 12 forms the other electrode of the load sensor 1 (capacitance-type load sensor), and the dielectric body 13b (see FIGS. 3A, 3B) included in the conductor wire 13 corresponds to a dielectric body that defines the capacitance in the load sensor 1 (capacitance-type load sensor).

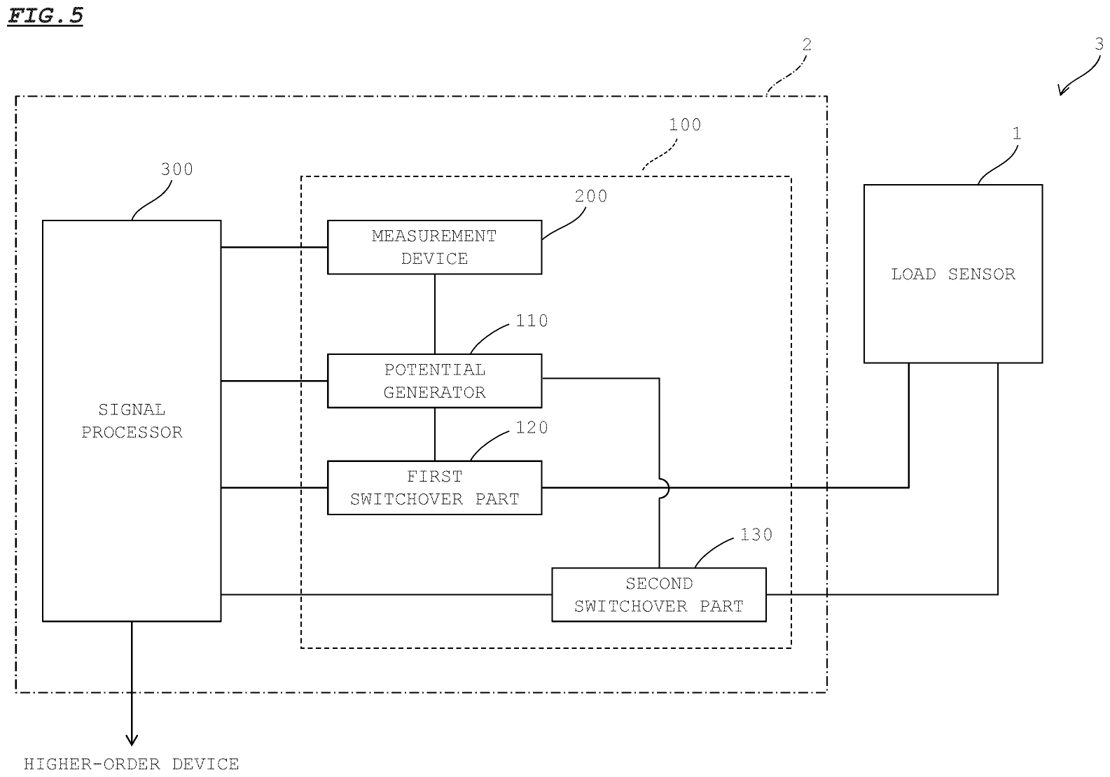

When a load is applied in the Z-axis direction to each element part, the conductor wire 13 is wrapped by the electrically-conductive elastic body 12. Accordingly, the contact area between the conductor wire 13 and the electrically-conductive elastic body 12 changes, and the capacitance between the conductor wire 13 and the electrically-conductive elastic body 12 changes. An end portion on the X-axis negative side of each conductor wire 13 and an end portion on the Y-axis negative side of the wiring cable W2 set to each electrically-conductive elastic body 12 are connected to a detection unit 2 described later with reference to FIG. 5.

When a load is applied to the element part A11, the contact area between the electrically-conductive member 13a of the conductor wire 13 and the electrically-conductive elastic body 12 increases via the dielectric body 13b in the element part A11. In this case, when the capacitance between the electrically-conductive elastic body 12 on the most X-axis negative side and the conductor wire 13 on the most Y-axis positive side is detected, the load applied to the element part A11 can be calculated. Similarly, in another element part as well, when the capacitance between the electrically-conductive elastic body 12 and the conductor wire 13 crossing each other in the other element part is detected, the load applied to the other element part can be calculated.

FIG. 5 is a block diagram showing a configuration of a load detection system 3.

The load detection system 3 includes the load sensor 1 described above and the detection unit 2. The detection unit 2 detects the capacitance in each element part of the load sensor 1. As described above, the capacitance in each element part changes in accordance with the load applied to the element part. The detection unit 2 detects the capacitance, in each element part, that changes in accordance with the load, by applying a voltage to the element part.

The detection unit 2 includes a voltage applier 100, a measurement device 200, and a signal processor 300. The measurement device 200 is included in the voltage applier 100.

The voltage applier 100 applies predetermined potentials to both electrodes of each element part, to apply a voltage according to the potential difference between these potentials, to the element part. The voltage applier 100 includes a potential generator 110, a first switchover part 120, and a second switchover part 130. The potential generator 110 generates potentials to be applied to both electrodes of each element part. The first switchover part 120 selectively applies a potential generated by the potential generator 110, to the three conductor wires 13 of the load sensor 1. The second switchover part 130 selectively applies a potential generated by the potential generator 110, to the three electrically-conductive elastic bodies 12 of the load sensor 1.

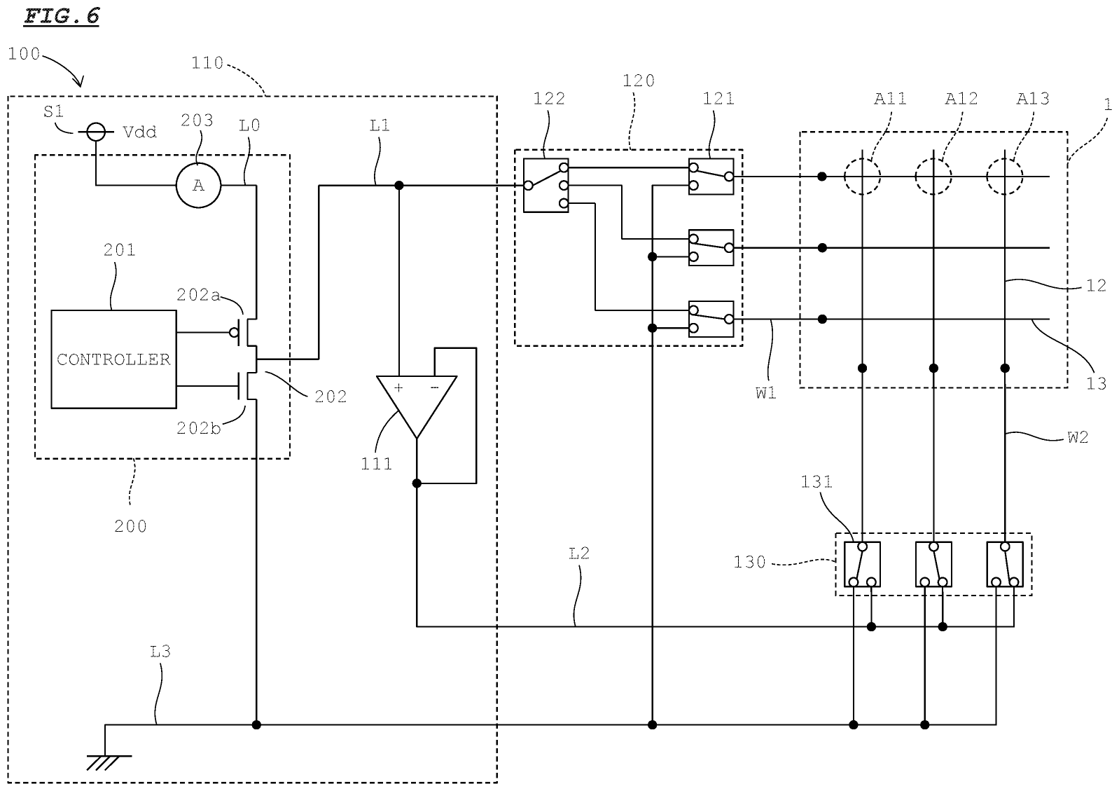

The measurement device 200 measures an electric quantity according to the electric charge amount accumulated in the element part through application of the voltage. Here, as this electric quantity, the current flowing in a supply line L0 (see FIG. 6) of the potential generator 110 is measured by the measurement device 200.

The signal processor 300 is implemented by a microcomputer or the like. The signal processor 300 controls the first switchover part 120 and the second switchover part 130, to apply the potential generated by the potential generator 110 to a predetermined element part of the load sensor 1. Then, the signal processor 300 acquires, from the measurement device 200, a measurement value of the current measured by the measurement device 200 in accordance with application of the potential, and detects the capacitance in each element part, based on the acquired measurement value.

FIG. 6 is a circuit diagram showing a configuration of the voltage applier 100.

The voltage applier 100 includes the potential generator 110, the first switchover part 120, and the second switchover part 130. The potential generator 110 includes the measurement device 200 and an equipotential generator 111. The potential generator 110 generates a potential to be applied to the element part of the load sensor 1, using the measurement device 200 and the equipotential generator 111.

The measurement device 200 includes a controller 201, a switchover part 202, and a measurer 203. The controller 201 is implemented by a microcomputer, an FPGA, or the like. The controller 201 controls the switchover part 202 and the measurer 203 to measure the current (electric quantity) that changes to be saturated in the supply line L0. The switchover part 202 switches application and non-application of a power supply potential Vdd to a supply line L1. The switchover part 202 has switching elements 202a, 202b connected in series between the supply line L1 and a ground line L3.

The measurer 203 includes a resistor interposed in the supply line L0, and measures the current flowing in the supply line L0. That is, when the switching element 202a is in a conductive state and the switching element 202b is in a non-conductive state, the measurer 203 measures the current flowing in the supply line L0, i.e., the current according to the amount of electric charge that moves via the supply lines L0, L1 and the first switchover part 120 to the load sensor 1. The measurer 203 may be disposed at another position on the path extending from a power supply S1 via the switching element 202a to a multiplexer 122.

During current measurement, the controller 201 outputs a gate signal for making the switching elements 202a, 202b conductive. The switching element 202a is implemented by a P-type FET and becomes conductive by a low-level gate signal being applied to the gate. The switching element 202b is implemented by an N-type FET and becomes conductive by a high-level gate signal being applied to the gate.

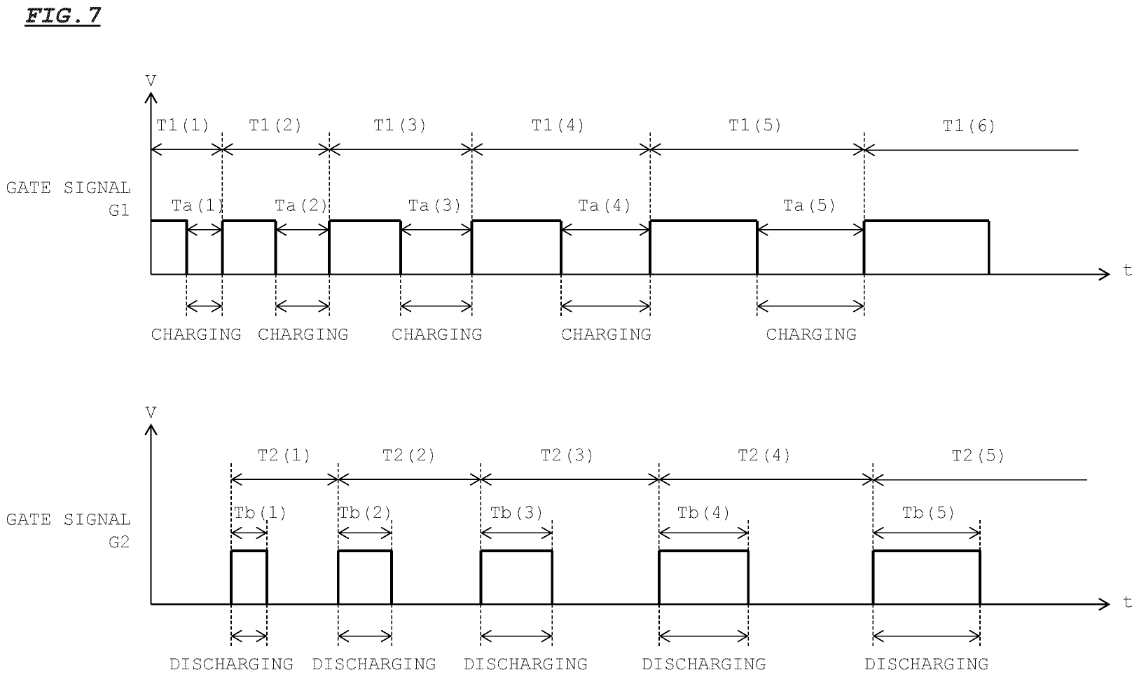

FIG. 7 is a time chart showing gate signals outputted from the controller 201 to the switching elements 202a, 202b, respectively, during current measurement with respect to an element part serving as the measurement target.

A gate signal G1 on the upper row is a signal that is supplied to the gate of the switching element 202a. A gate signal G2 on the lower row is a signal that is supplied to the gate of the switching element 202b.

As shown in FIG. 7, during current measurement with respect to one element part serving as the measurement target, the controller 201 outputs a plurality of the gate signals G1 whose periods T1(n)(n is a positive natural number) are different, to the gate of the switching element 202a. The period T1(n) becomes longer in association with increase in the variable n. The gate signal G1 in each period T1(n) is at a low level in a period Ta(n) and is at a high level in the other periods. The ratio (duty) of the period Ta(n) to the period T1(n) is constant. This ratio (duty) is 50%, for example. Therefore, between the plurality of the gate signals G1, the periods Ta(n) are different from each other. The period Ta(n) in each gate signal G1 becomes longer in association with increase in the variable n.

During detection of the capacitance with respect to one element part, the controller 201 outputs a plurality of the gate signals G2 whose periods T2(n)(n is a positive natural number) are different, to the gate of the switching element 202b. The period T2(n) becomes longer in association with increase in the variable n. The gate signal G2 in each period T2(n) is at a high level in a period Tb(n) and is at a low level in the other periods. The ratio (duty) of the period Tb(n) to the period T2(n) is constant. This ratio (duty) is 50%, for example. Therefore, between the plurality of the gate signals G2, the periods Tb(n) are different from each other. The period Tb(n) in each gate signal G2 becomes longer in association with increase in the variable n.

The period T2(n) of the gate signal G2 has the same length as the period T1(n+1) of the gate signal G1, and the period Tb(n) of the gate signal G2 has the same length as the period Ta(n) of the gate signal G1. The gate signal G2, in the period Tb(n), is outputted at a timing when the period Tb(n) falls within an approximately center portion in the high-level period of the period T1(n+1) of the gate signal G1. Therefore, between the end timing of the period Ta(n) and the start timing of the period Tb(n), a certain time gap occurs, and between the end timing of the period Tb(n) and the start timing of the period Ta(n+1), a certain time gap occurs.

In the period Ta(n), the switching element 202a becomes conductive, and the power supply potential Vdd is applied to the element part serving as the measurement target. That is, the controller 201 starts application of the power supply potential Vdd in synchronization with start of the period Ta(n). In this period Ta(n), the controller 201 causes the measurer 203 to measure the current flowing in the supply line L0. Thus, the period Ta(n) corresponds to the measurement period for the current. In this manner, during current measurement with respect to the element part serving as the measurement target, the controller 201 sets a plurality of measurement periods different from each other, to measure the current flowing in the supply line L0.

In the period Tb(n), the switching element 202b becomes conductive and discharging with respect to the element part serving as the measurement target is performed. That is, the electric charge accumulated in the element part serving as the measurement target through application of the power supply potential Vdd in the period Ta(n) is discharged to the ground line L3 due to conduction of the switching element 202b in the subsequent period Tb(n). Then, in the subsequent period Ta(n+1), again, charging with respect to the element part serving as the measurement target is performed, and measurement of the current is performed. Thereafter, the same process is repeated, and measurement of the current is performed for each period Ta(n).

In FIG. 7, six periods T1(n) and five periods T2(n) are shown. However, the period T1(n) and the period T2(n) continue also after the periods T1(6), T2(5). These periods T1(n) and periods T2(n) also become longer in association with increase in the variable n, as in the above.

With reference back to FIG. 6, the equipotential generator 111 is an operational amplifier, generates a potential equal to the potential in the supply line L1, and applies the generated potential to the supply line L1.

The first switchover part 120 selectively connects either one of the supply line L1 and the ground line L3 to wiring cables W1 respectively drawn from a plurality of conductor wires 13 (the electrically-conductive members 13a).

Specifically, the first switchover part 120 includes three multiplexers 121 and one multiplexer 122. The supply line L1 is connected to the input-side terminal of the multiplexer 122. The multiplexer 122 is provided with three output-side terminals. The three multiplexers 121 are respectively connected to the three output-side terminals of the multiplexer 122. The three multiplexers 121 are provided so as to correspond to the three conductor wires 13 (the electrically-conductive members 13a), respectively. To the output-side terminal of each multiplexer 121, the electrically-conductive member 13a (the wiring cable W1) of a corresponding conductor wire 13 is connected.

Each multiplexer 121 is provided with two input-side terminals. The multiplexer 122 is connected to one input-side terminal of the multiplexer 121, and to this input-side terminal, the power supply potential Vdd is applied via the supply line L1. The power supply potential Vdd is a potential generated by the power supply S1. The other input-side terminal of the multiplexer 121 is connected to the ground line L3.

The second switchover part 130 selectively connects either one of a supply line L2 and the ground line L3 to each electrically-conductive elastic body 12 (the wiring cable W2).

Specifically, the second switchover part 130 includes three multiplexers 131. The three multiplexers 131 are provided so as to correspond to the three electrically-conductive elastic bodies 12, respectively. To the output-side terminal of each multiplexer 131, the wiring cable W2 connected to a corresponding electrically-conductive elastic body 12 is connected. Each multiplexer 131 is provided with two input-side terminals. The supply line L2 is connected to one input-side terminal of the multiplexer 131. The ground line L3 is connected to the other input-side terminal of the multiplexer 131.

The first switchover part 120 and the second switchover part 130 are controlled by the signal processor 300 in FIG. 5. Accordingly, the power supply potential Vdd, the potential from the equipotential generator 111, or the ground potential is applied to the three conductor wires 13 (the wiring cables W1) and the three electrically-conductive elastic bodies 12 (the wiring cables W2).

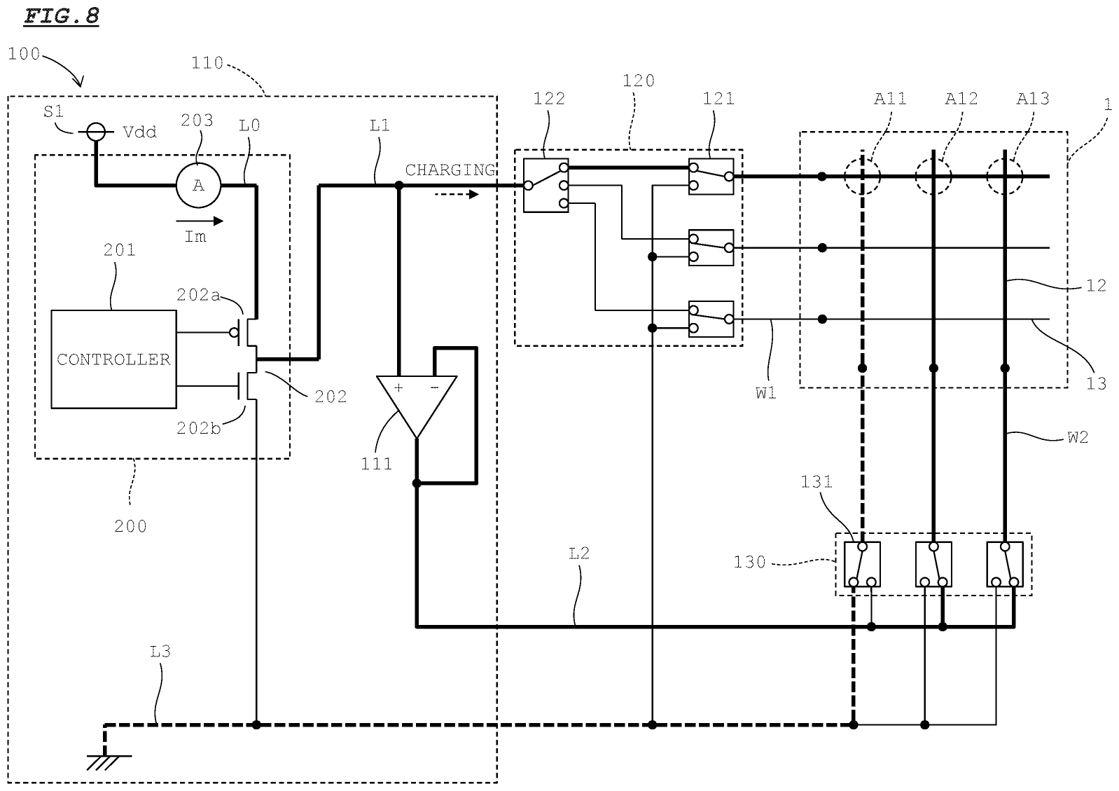

FIG. 8 shows a state of the voltage applier 100 when applying a voltage to an element part serving as the measurement target.

Here, the element part A11 in FIG. 6 is the measurement target. In FIG. 8, the thick solid line indicates the path along which a potential equivalent to the power supply potential Vdd is applied to the load sensor 1, and the thick broken line indicates the path of the ground potential.

When the capacitance detection target is the element part A11, the multiplexers 121, 122 of the first switchover part 120 and the multiplexers 131 of the second switchover part 130 are set to be in the state in FIG. 6. In this state, when the switching element 202a is switched into a conductive state due to the gate signals G1, G2 in FIG. 7, the power supply potential Vdd is applied to the conductor wire 13 in the row including the element part A11 of the load sensor 1, as shown in FIG. 8. Accordingly, the power supply potential Vdd is applied to one electrode (the conductor wire 13) of each of the three element parts A11 to A13 in this row.

At this time, as for the other electrodes (the three electrically-conductive elastic bodies 12) of these three element parts A11 to A13, only the element part A11 is connected to the ground via the second switchover part 130, and the other element parts A12, A13 are connected to the supply line L2. Therefore, among these element parts A11 to A13, different potentials are applied to both electrodes of the element part A11, and the same potential is applied to the element parts A12, A13. Therefore, electric charge is accumulated in the element part A11, and electric charge is not accumulated in the element parts A12, A13. With respect to the element parts other than the element parts A11 to A13, one electrode (the conductor wire 13) is open, and thus, electric charge is not accumulated. Therefore, in the state in FIG. 8, charging (accumulation of electric charge) with respect to the element part A11 is mainly performed.

A current Im flowing in the supply line L0 during this charging is measured by the measurer 203. The current Im flows in the supply line L0 in the period Ta(n) in FIG. 7. The controller 201 calculates an average current value Im_av of the current Im from the measurement value obtained by the measurement device 200.

Then, when the period Ta(n) has ended, the switching element 202a becomes non-conductive, and application of the power supply potential Vdd to the supply line L1 is blocked. Then, when the period Tb(n) in FIG. 7 has arrived, the switching element 202b becomes conductive, and discharging with respect to the element part A11 is performed.

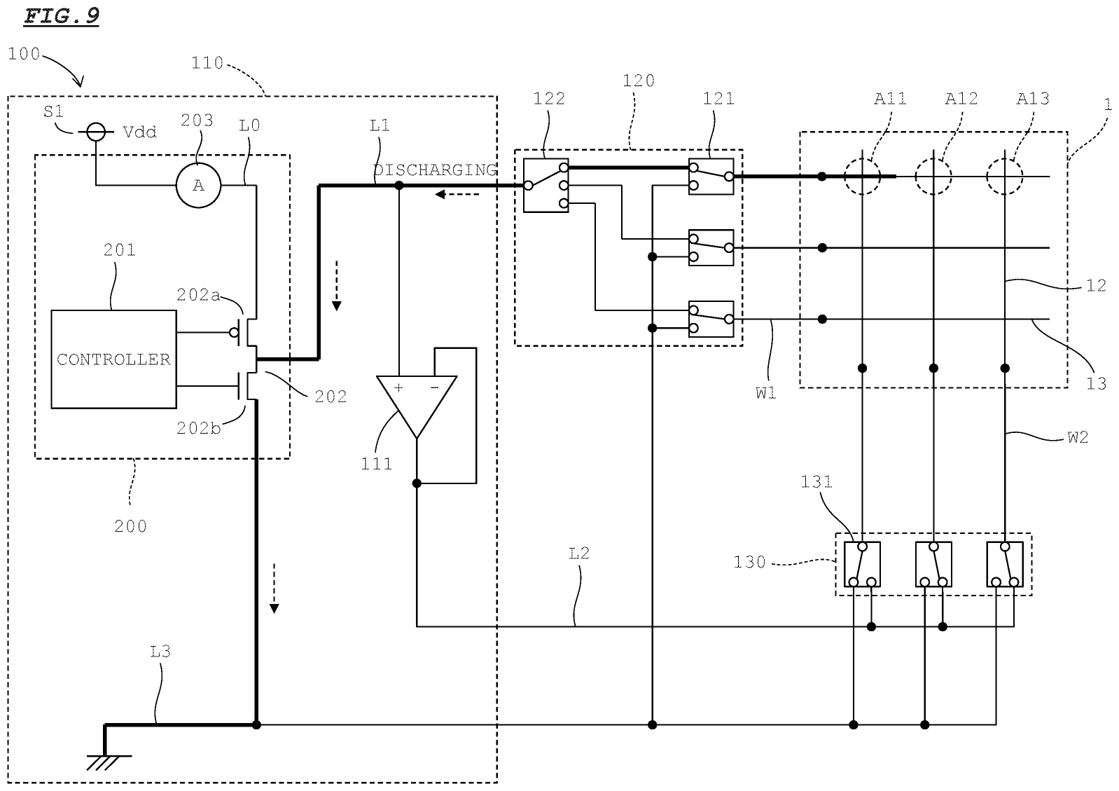

FIG. 9 shows a state of the voltage applier 100 when performing discharging with respect to an element part serving as the measurement target.

In FIG. 9, the thick solid line indicates the path of the current flowing to the ground.

As indicated by the broken line arrows in FIG. 9, the current flows from the supply line L1 to the ground line L3, and the electric charge charged in the element part A11 is discharged to the ground. Then, when the period Tb(n) has ended, the switching element 202b becomes non-conductive, and connection of the ground line L3 to the supply line L1 is blocked. Then, when the next period Ta(n+1) has arrived, the power supply potential Vdd in the supply line L1 is applied and a voltage is applied to the element part A11, as in the case of FIG. 8. Then, upon arrival of the period Tb(n+1), discharging with respect to the element part A11 is performed, as in the case of FIG. 9. In this manner, charging and discharging with respect to the element part A11 are repeated.

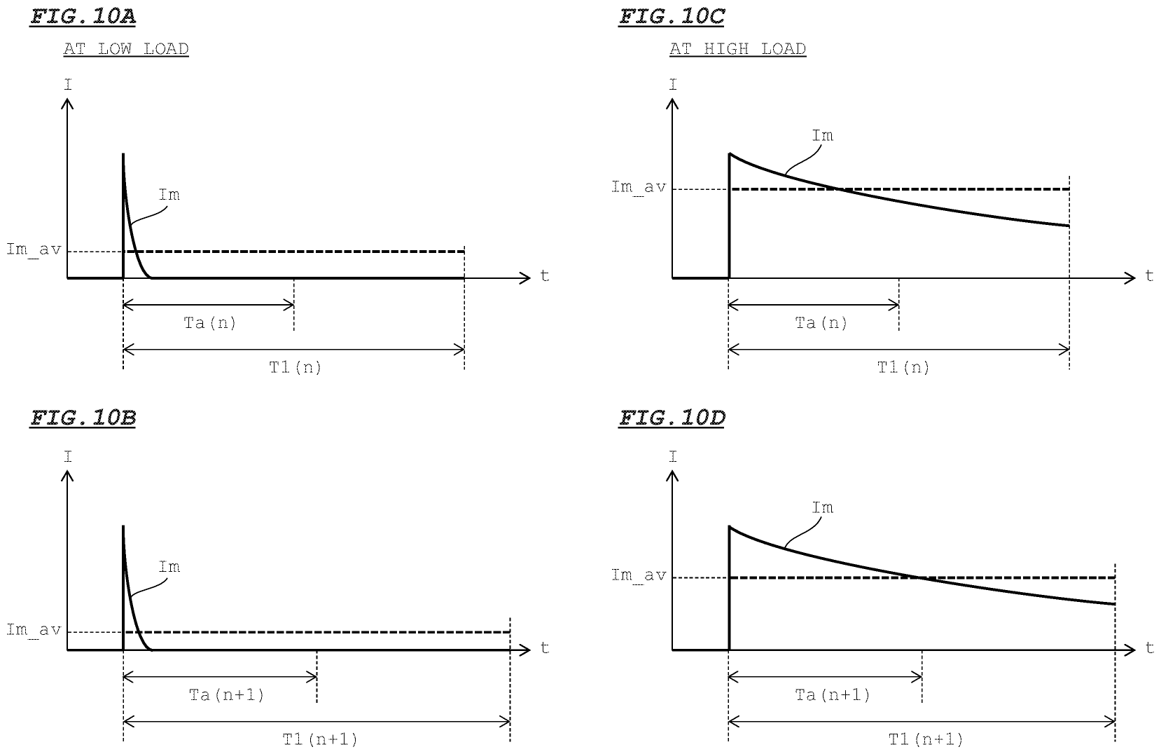

FIGS. 10A to 10D are each a graph showing a relationship between the measurement period and the current Im measured by the measurer 203.

FIGS. 10A, 10B each show a graph when the load being applied to the element part A11 serving as the measurement target is small. FIGS. 10C, 10D each show a graph when the load being applied to the element part A11 serving as the measurement target is large. FIGS. 10A, 10C each show a relationship between the period Ta(n) and the current Im. FIGS. 10B, 10D each show a relationship between the next period Ta(n+1) and the current Im.

As shown in FIGS. 10A, 10B, when the load being applied to the element part A11 is small, the capacitance in the element part A11 is small. Thus, the period (the period from when the current Im starts to flow until the current Im converges to zero) until the current Im becomes saturated is short.

Therefore, the current Im becomes saturated within the range of the periods Ta(n), Ta(n+1). In this case, when the average current values Im_av(n), Im_av(n+1) with respect to the period T1(n) and the period T1(n+1) are calculated, the following relationship is satisfied.

$$Im\_av ( n ) / Im\_av ( n + 1 ) = Ta ( n + 1 ) / Ta ( n ) \qquad ( 1 )$$

The average current values Im_av(n), Im_av(n+1) may be calculated with respect to the periods Ta(n), Ta(n+1). In this case as well, the relationship of the above formula (1) is satisfied. Since the ratio (duty) between Ta(n) and T1(n) is the same as the ratio between Ta(n+1) and T1(n+1), even if the right side of the above formula (1) is T1(n+1)/T1(n) instead of Ta(n+1)/Ta(n), the above relationship is satisfied.

As shown in FIGS. 10C, 10D, when the load being applied to the element part A11 is large, the capacitance in the element part A11 is large. Thus, the period (the period from when the current Im starts to flow until the current Im converges to zero) until the current Im becomes saturated is long. Therefore, the current Im is not saturated within the range of the periods Ta(n), Ta(n+1), and the relationship of the above formula (1) is not satisfied. Then, when the variable n becomes larger than that in the cases of FIGS. 10C, 10D, and the period until the current Im becomes saturated becomes equal to or less than the period Ta(n), the relationship of the above formula (1) is satisfied. Therefore, based on whether or not the relationship of the above formula (1) is satisfied, whether or not the current Im has become saturated within the range of the period Ta(n) serving as the measurement period can be determined.

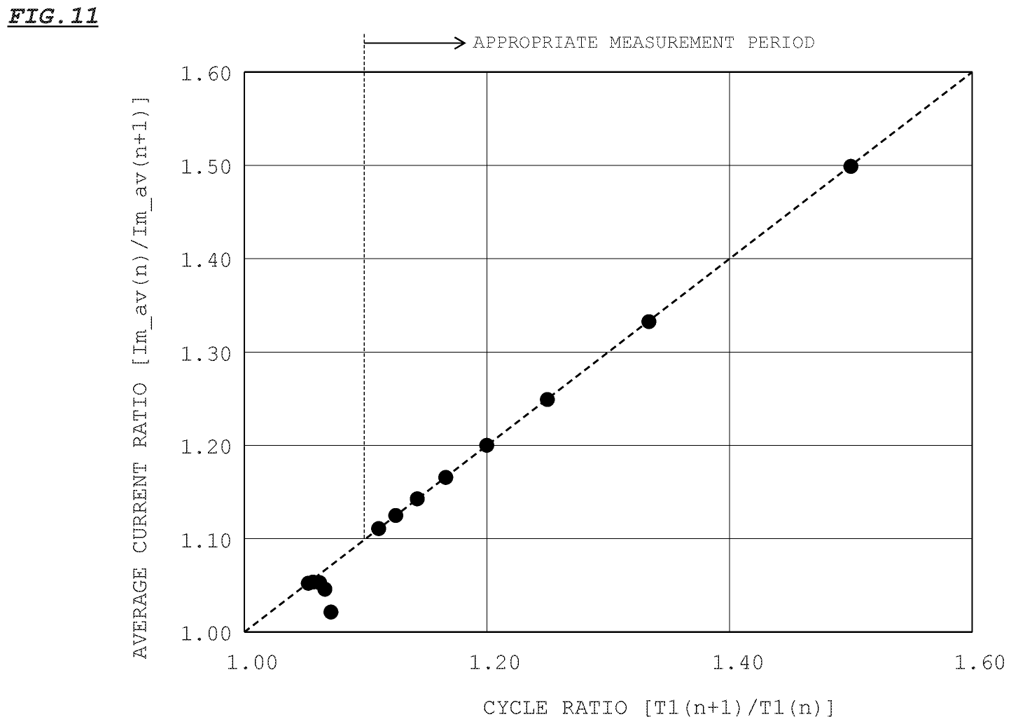

FIG. 11 is a graph showing a simulation result of a relationship, when the capacitance in an element part serving as the measurement target has a predetermined value, between: the ratio (cycle ratio) between the periods T1(n) and T1(n+1); and the ratio (average current ratio) between the average current values Im_av(n) and Im_av(n+1).

In the simulation result in FIG. 11, the horizontal axis represents the cycle ratio T1(n+1)/T1(n), but even when the horizontal axis represents the measurement period ratio Ta(n+1)/Ta(n), a similar simulation result can be obtained. That is, the simulation result in FIG. 11 is equivalent to that when the horizontal axis represents the measurement period ratio Ta(n+1)/Ta(n).

As shown in FIG. 11, in this simulation, in a range where the cycle ratio is smaller than 1.1, the relationship between the cycle ratio and the average current ratio did not satisfy linearity. This corresponds to a fact that the relationship of the above formula (1) is not satisfied in this range. This is due to the fact that, in this range, the period until the current Im becomes saturated is longer than the period Ta(n) as in FIGS. 10C, 10D.

In contrast, in a range where the cycle ratio is equal to or larger than 1.1, the relationship between the cycle ratio and the average current ratio satisfied linearity. This corresponds to a fact that the relationship of the above formula (1) is satisfied in this range. This is due to the fact that, in this range, the period until the current Im becomes saturated is equal to or less than the period Ta(n) as in FIGS. 10A, 10B.

As described above, it was possible to confirm that, based on whether or not the relationship between the cycle ratio and the average current ratio satisfies linearity, i.e., based on whether or not the relationship of the above formula (1) is satisfied, whether or not the current Im has become saturated within the range of the period Ta(n) serving as the measurement period can be determined. Therefore, when the period Ta(n) in the range where the relationship between the cycle ratio and the average current ratio satisfies linearity, i.e., the range where the relationship of the above formula (1) is satisfied, is used as an appropriate measurement period for the current Im, the current Im in the period from when the current Im starts to flow until the current Im becomes saturated can be measured, and the average current value Im_av based on the saturated current amount can be appropriately acquired.

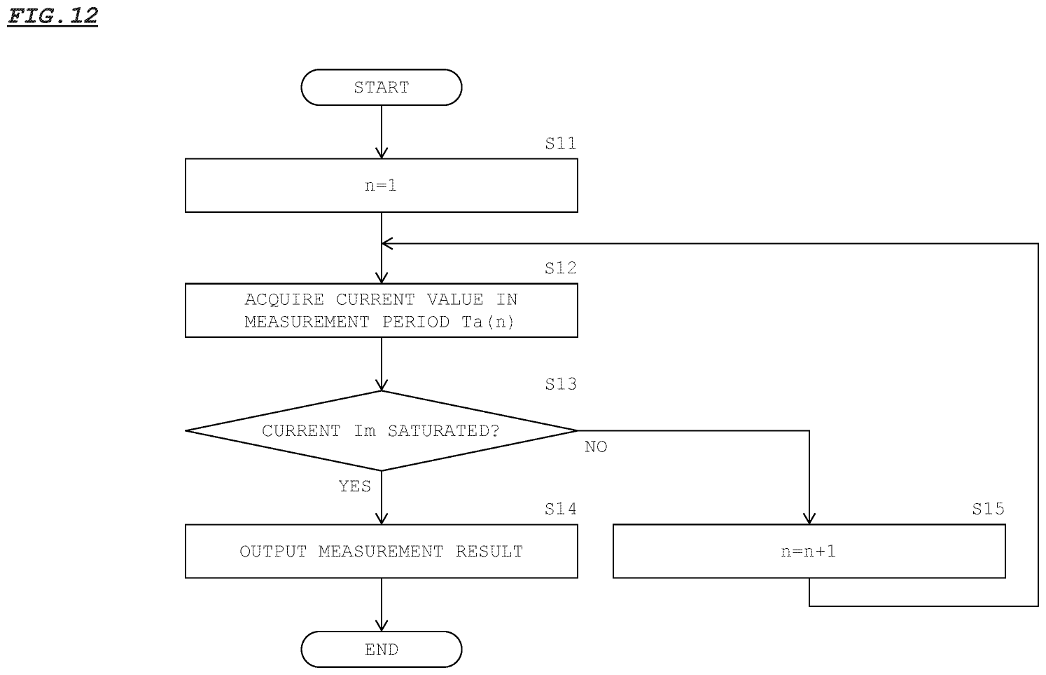

FIG. 12 is a flowchart showing a process of acquiring a measurement result of the current Im with respect to an element part serving as the measurement target.

When the element part serving as the measurement target is the element part A11 in FIG. 6, the first switchover part 120 and the second switchover part 130 are set to be in the state in FIG. 6 by the signal processor 300. In this state, discharging with respect to all the element parts of the load sensor 1 has been completed. Then, the controller 201 of the measurement device 200 starts output of the gate signals G1, G2 in FIG. 7 and executes the process in FIG. 12.

The controller 201 sets 1 as the variable n (S11) and acquires the measurement value of the current Im in the period Ta(n) from the measurer 203 (S12). When the measurement of the current Im in the period Ta(n) has ended, the controller 201 determines whether or not (whether or not the current has converged to zero) the current Im has become saturated in the period Ta(n), from the acquired measurement value of the current Im (S13). When the determination in step S13 is NO, the controller 201 adds 1 to the variable n (S15), and returns the process to step S12. Accordingly, the controller 201 acquires the measurement value of the current Im in the next period Ta(n) (S12), and determines whether or not the current Im has become saturated in the period Ta(n) from the acquired measurement value (S13).

Until the determination in step S13 becomes YES, the controller 201 executes the same process while increasing the variable n. Then, when the determination in step S13 has become YES, the controller 201 outputs the measurement result of the current Im measured in the period Ta(n) at that time, to the signal processor 300, and ends outputting of the gate signals G1, G2 (S14). Accordingly, the controller 201 ends the process in FIG. 12.

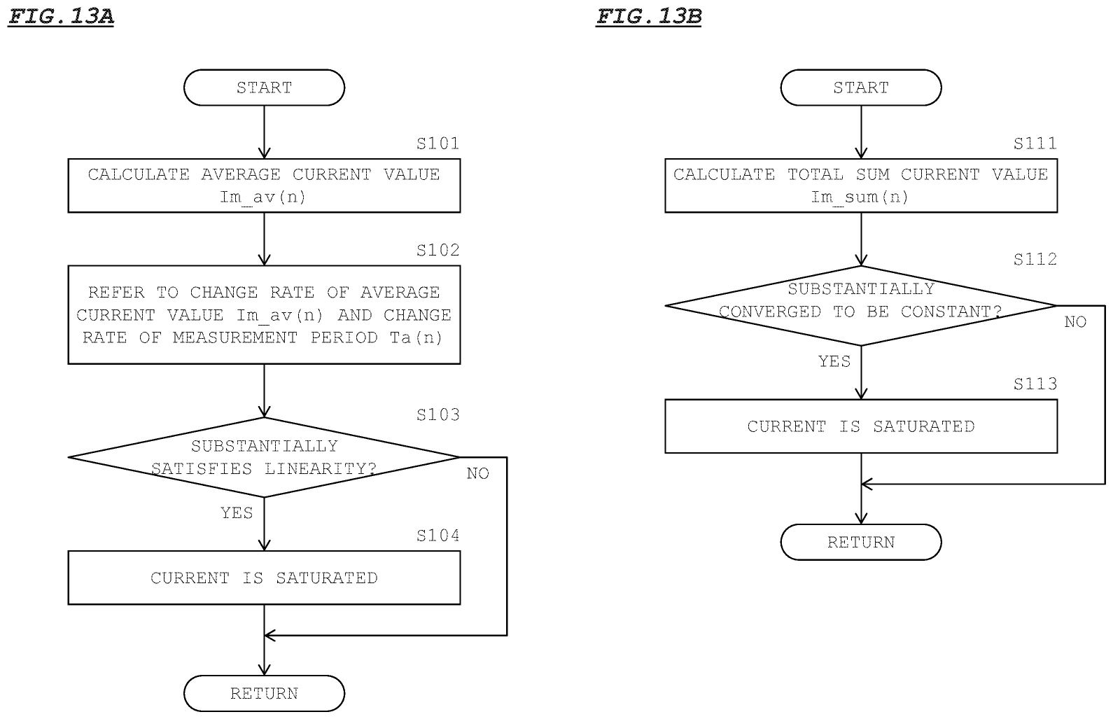

FIG. 13A is a flowchart showing the process in step S13 in FIG. 12.

The controller 201 calculates the average current value Im_av(n) of the current Im from the current Im acquired in the period Ta(n)(S101). The controller 201 refers to a change rate Im_av(n−1)/Im_av(n) between an average current value Im_av(n−1) calculated with respect to the immediately-preceding period Ta(n−1) and the average current value Im_av(n), and a change rate Ta(n)/Ta(n−1) between the period Ta(n) and the immediately-preceding period Ta(n−1)(S102), and determines whether or not the relationship between both change rates substantially satisfies linearity (S103).

The determination in step S103 is made, as in the above formula (1), based on whether or not the change rate Im_av(n−1)/Im_av(n) and the change rate Ta(n)/Ta(n−1) are substantially equal to each other, for example, whether or not the difference between both change rates is within several %.

The determination in step S103 may become YES when a fact that these two change rates are substantially equal to each other has been maintained while the variable n has been increased several times (e.g., five times). Accordingly, the fact that the current Im has become saturated in the period Ta(n) can be more accurately determined.

When the determination in step S103 is YES, the controller 201 determines that the current has become saturated in the period Ta(n)(S104), and sets the determination in step S13 in FIG. 12 to YES. On the other hand, when the determination in step S103 is NO, the controller 201 skips step S104 and sets the determination in step S13 in FIG. 12 to NO. Accordingly, the controller 201 ends the process in FIG. 13A.

When the process in FIG. 13A is performed in step S13 in FIG. 12, the controller 201 outputs, to the signal processor 300, a value obtained by multiplying, by the period T1(n), the average current value Im_av(n) at the time when the determination in step S103 has become YES, i.e., an electric charge amount Qm(n) accumulated in the element part A11 serving as the measurement target, as the measurement result in step S14. In this case, the signal processor 300 calculates a capacitance C in the element part A11 by the following formula.

$$C = Qm ( n ) / Vdd \qquad ( 2 )$$

Alternatively, the controller 201 may output, to the signal processor 300, the average current value Im_av(n) at the time when the determination in step S103 has become YES and the period T1(n) at that time, as the measurement result. In this case, the signal processor 300 obtains the electric charge amount Qm(n) from the received average current value Im_av(n) and period T1(n), and calculates the capacitance from the above formula (2).

In the process in FIG. 12, the larger the load applied to the element part A11 is, i.e., the larger the capacitance in the element part A11 is, the larger the number of times of repetition of steps S12, S13, S15 becomes. However, when a period Ta(n) appropriate for the magnitude of the capacitance in the element part A11 has been reached, the determination in step S13 becomes YES, and the process in a period Ta(n) longer than that is not performed any more. Therefore, based on the period Ta(n) that is appropriate for the element part A11, an efficient and highly accurate measurement result can be acquired.

The process in step S13 in FIG. 12 may be the process in FIG. 13B. In this case, the controller 201 accumulates all the current values acquired in the period Ta(n) to calculate a total sum current value Im_sum(n)(S111), and determines whether or not the calculated total sum current value Im_sum(n) has substantially converged to be constant (S112). In step S112, the controller 201 determines whether or not the difference between the total sum current value Im_sum(n) calculated this time and a total sum current value Im_sum(n−1) calculated last time is within a range of error. Alternatively, in step S112, the controller 201 determines whether or not the ratio between the total sum current value Im_sum(n) calculated this time and the total sum current value Im_sum(n−1) calculated last time is within a range of error having 1 at the center thereof.

In this case as well, the determination in step S112 may be set to YES when a fact that the above-described difference or ratio is within the range of error is maintained while the variable n has been increased several times (e.g., five times). Accordingly, the fact that the current Im has become saturated in the period Ta(n) can be more accurately determined.

In this case, the total sum current value Im_sum(n) calculated in step S111 is the electric charge amount accumulated in the element part A11 in the period Ta(n). Therefore, when the process in FIG. 13B is performed in step S13 in FIG. 12, the controller 201 may output, to the signal processor 300, the total sum current value Im_sum(n) at the time when the determination in step S112 has become YES, as the measurement result in step S14. In this case, the signal processor 300 applies the acquired total sum current value Im_sum(n), as Qm(n), to formula (2) to calculate the capacitance C in the element part A11.

When having acquired the capacitance with respect to the element part A11 serving as the measurement target through the process described above, the signal processor 300 switches the element part A11 serving as the measurement target to the next element part. For example, when the next measurement target is the element part A12 in FIG. 6, the first switchover part 120 and the second switchover part 130 are set such that the power supply potential Vdd and the ground potential are applied only to both electrodes of the element part A12. Specifically, the multiplexers 131 at the left end and at the right end of the second switchover part 130 are connected to the supply line L2, and the center multiplexer 131 is connected to the ground line L3. As the connection state of the first switchover part 120, the state in FIG. 6 is maintained.

In this state, the controller 201 executes the process in FIG. 12, and outputs the measurement result of the current Im to the signal processor 300. Accordingly, the measurement result according to the capacitance in the element part A12 is outputted from the controller 201 to the signal processor 300. The signal processor 300 applies the acquired measurement result to the above formula (2) to calculate the capacitance in the element part A12. Thereafter, in a similar manner, while the element part serving as the measurement target is switched sequentially, the process in FIG. 12 is executed, and the capacitances with respect to all the element parts are sequentially calculated.

### Effects of Embodiment

According to the above embodiment, the following effects can be exhibited.

As shown in FIG. 12, among a plurality of periods Ta(n) (measurement periods) different from each other, with respect to a period Ta(n)(measurement period) for which it has been determined that the current Im (electric quantity) serving as the measurement target has become saturated, a measurement result of the current Im (electric quantity) is acquired (S13, S14). Therefore, even when the period until the current Im (electric quantity) serving as the measurement target becomes saturated may change, the measurement period for the current Im (electric quantity) can be appropriately set. Therefore, a highly accurate measurement result can be efficiently acquired.

As shown in FIG. 7, the controller 201 sequentially changes the lengths of the plurality of periods Ta(n) (measurement periods) in one direction. Then, as shown in FIG. 13A, the controller 201 calculates the average current value Im_av(n) being the average value of the current Im (electric quantity) in each period Ta(n)(measurement period)(S101), and based on whether or not the relationship between the change rate of the period Ta(n)(measurement period) and the change rate of the average current value Im_av(n) substantially satisfies linearity (S103), determines whether or not the current Im (electric quantity) has become saturated (S104). Accordingly, as described with reference to FIGS. 10A to 10D and FIG. 11, whether or not the current Im (electric quantity) has become saturated in the period Ta(n)(measurement period) can be accurately determined. Further, the average current value Im_av(n) at the time when the determination in step S103 has become YES can be used in calculation of the capacitance based on formula (2).

As shown in FIG. 7, the controller 201 sequentially changes the lengths of the plurality of periods Ta(n) (measurement periods) in one direction. Then, as shown in FIG. 13B, based on whether or not the total sum current value Im_sum (n) being the total sum of the current Im (electric quantity) acquired in each period Ta(n)(measurement period) has substantially converged to be constant (S112), the controller 201 determines whether or not the current Im (electric quantity) has become saturated (S113). Through this process as well, whether or not the current Im (electric quantity) has become saturated in the period Ta(n)(measurement period) can be appropriately determined. Further, the total sum current value Im_sum (n) at the time when the determination in step S112 has become YES can be used in calculation of the capacitance based on formula (2).

As shown in FIG. 7, the controller 201 sequentially increases the lengths of the plurality of periods Ta(n) (measurement period). Accordingly, the length of the period Ta(n)(measurement period) can be gradually made close to the length at which the current Im (electric quantity) is saturated. Therefore, an appropriate period Ta(n)(measurement period) can be smoothly set.

As shown in FIG. 8, the measurement device 200 measures the current flowing in the supply line L0 (predetermined portion of the voltage applier) during application of the power supply potential Vdd, as the electric quantity that changes due to charging of electric charge with respect to an element part. Accordingly, a period Ta(n)(measurement period) according to change in the current Im can be appropriately set, and a measurement result of the current Im according to the electric charge amount in the element part serving as the measurement target can be accurately acquired. Therefore, from this measurement result, the capacitance in the element part serving as the measurement target can be appropriately acquired.

As shown in FIG. 6, the load sensor 1 includes a plurality of element parts, the voltage applier 100 is configured to be able to switch the element part to which a voltage is applied, and the signal processor 300 controls the voltage applier 100 to apply a voltage to each element part, acquires a measurement result with respect to each element part from the measurement device 200, and acquires the capacitance in each element part from the acquired measurement result. With this configuration, since a plurality of element parts are disposed, the load detection range can be widened. Since the above process is executed with respect to each element part, the capacitance applied to each element part can be accurately detected, and the load in each element part can be efficiently detected.

As shown in FIG. 6, the plurality of element parts are disposed in a matrix shape so as to be arranged in a plurality of rows and a plurality of columns. The element parts in the same row each have one of both electrodes thereof connected to each other, the element parts in the same column have the other of both electrodes thereof connected to each other, and the voltage applier 100 includes the multiplexers 121, 122, 131 (switching element) that switch the row and the column to which potentials are applied. With this configuration, since the plurality of element parts are disposed in a matrix shape, distribution of the load in an area spreading in a quadrangular shape can be detected by these element parts. In addition, since the row and the column to which potentials are applied are switched by the multiplexers 121, 122, 131 (switching element), a voltage can be selectively applied to the element part present at the crossing position of the row and the column after the switching, and the capacitance in the element part can be efficiently detected through the above control.

In the process in FIG. 12, when the determination in step S13 does not become YES before the variable n reaches a predetermined upper limit value, i.e., before the variable n reaches the upper limit value, when the relationship between the change rate of the measurement period and the change rate of the average current value does not satisfy substantial linearity in the process in FIG. 13A, or the total sum current value does not become substantially constant in the process in FIG. 13B, it may be determined that there is a possibility that a failure has occurred in the load sensor 1 or the element part. That is, the total sum current value or the correlation between the change rate of the measurement period and the change rate of the average current value can further be used also in failure diagnosis of the load sensor 1 or the element part.

### <Modification 1>

In the above embodiment, through the process in FIG. 13A or FIG. 13B, whether or not the current Im has converged in the period Ta(n)(measurement period) is determined. However, the method of determining whether or not the current Im has converged in the period Ta(n)(measurement period) is not limited thereto. For example, based on whether or not a current value Im_E measured by the measurer 203 at the end timing of the period Ta(n)(measurement period) is substantially zero, whether or not the current Im has converged in the period Ta(n) (measurement period) may be determined.

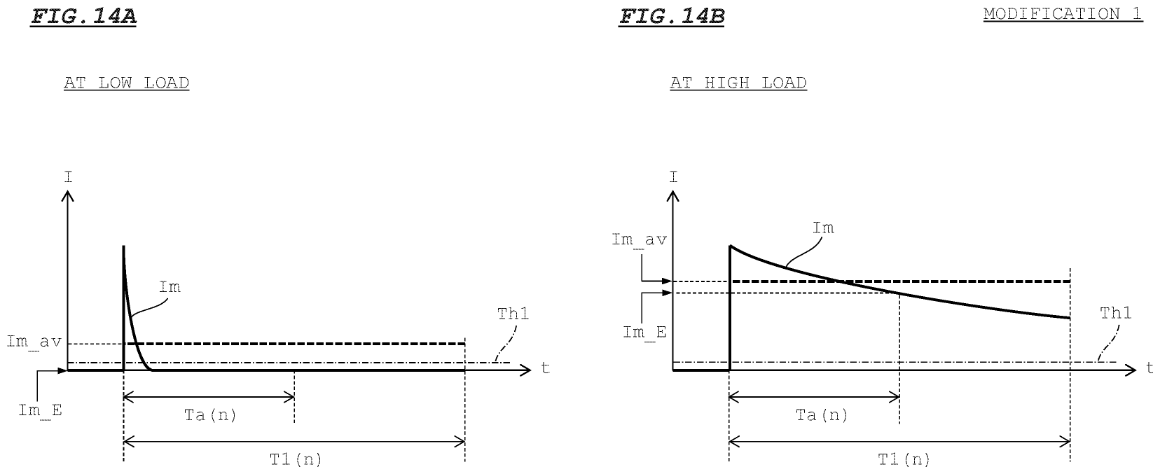

In this case, for example, as shown in FIGS. 14A, 14B, based on whether or not the current value Im_E is smaller than a threshold Th1, whether or not the current Im has converged in the period Ta(n) is determined. The threshold Th1 is set to a value slightly higher than a noise component that could occur after convergence of the current Im.

As in FIG. 14A, when the load being applied to the element part serving as the measurement target is small and the period until the current Im converges is shorter than the period Ta(n), the current value Im_E is smaller than the threshold Th1. On the other hand, as in FIG. 14B, when the load being applied to the element part serving as the measurement target is large and the period until the current Im converges is longer than the period Ta(n), the current value Im_E is larger than the threshold Th1. Therefore, based on whether or not the current value Im_E measured by the measurer 203 at the end timing of the period Ta(n) is smaller than the threshold Th1 (whether or not the current value Im_E is substantially zero), whether or not the current Im has converged in the period Ta(n)(measurement period) can be appropriately determined.

### <Modification 2>

In the above embodiment, the current Im that changes during charging with respect to the element part serving as the measurement target is measured by the measurer 203. However, the current that changes during discharging with respect to the element part serving as the measurement target may be measured by the measurer 203.

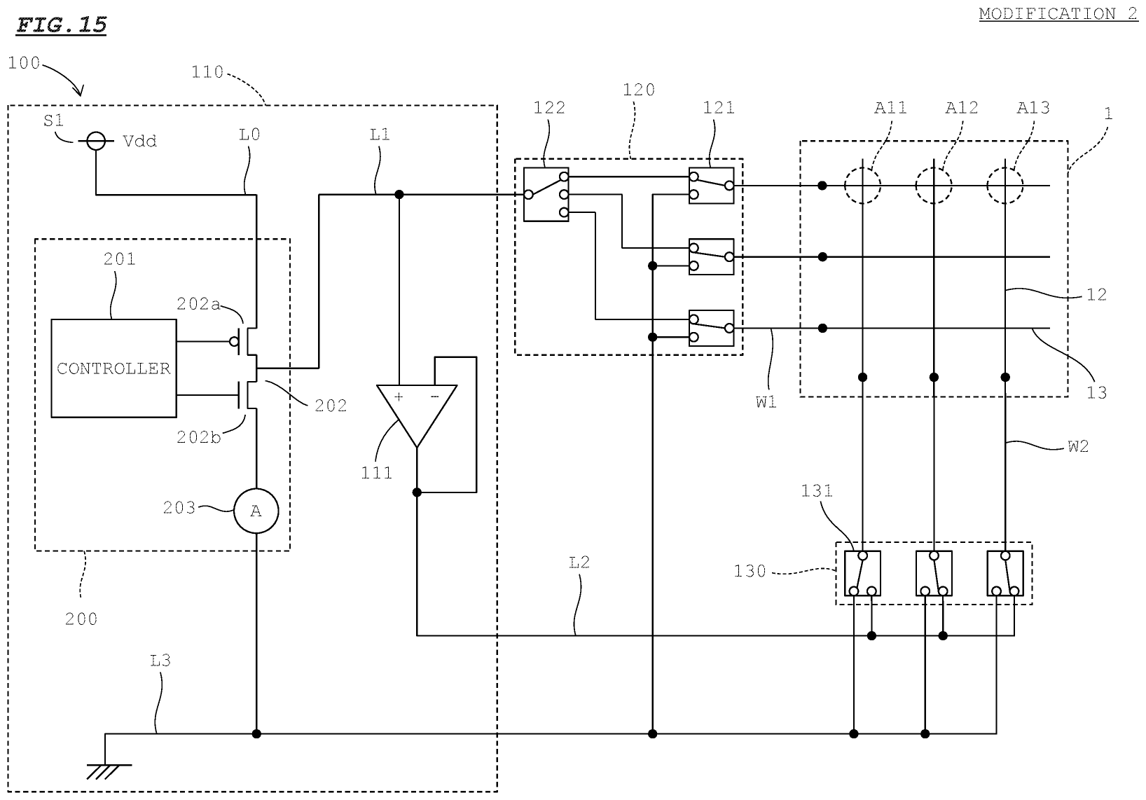

FIG. 15 shows a configuration of the measurement device 200 in this case.

In the configuration in FIG. 15, the measurer 203 is disposed on the path between the switching element 202b and the ground line L3. The measurer 203 measures the current Im flowing in the path between the switching element 202b and the ground line L3 during discharging with respect to the element part. The measurer 203 may be disposed at another position on the path extending from the multiplexer 122 to the ground line L3 via the switching element 202b.

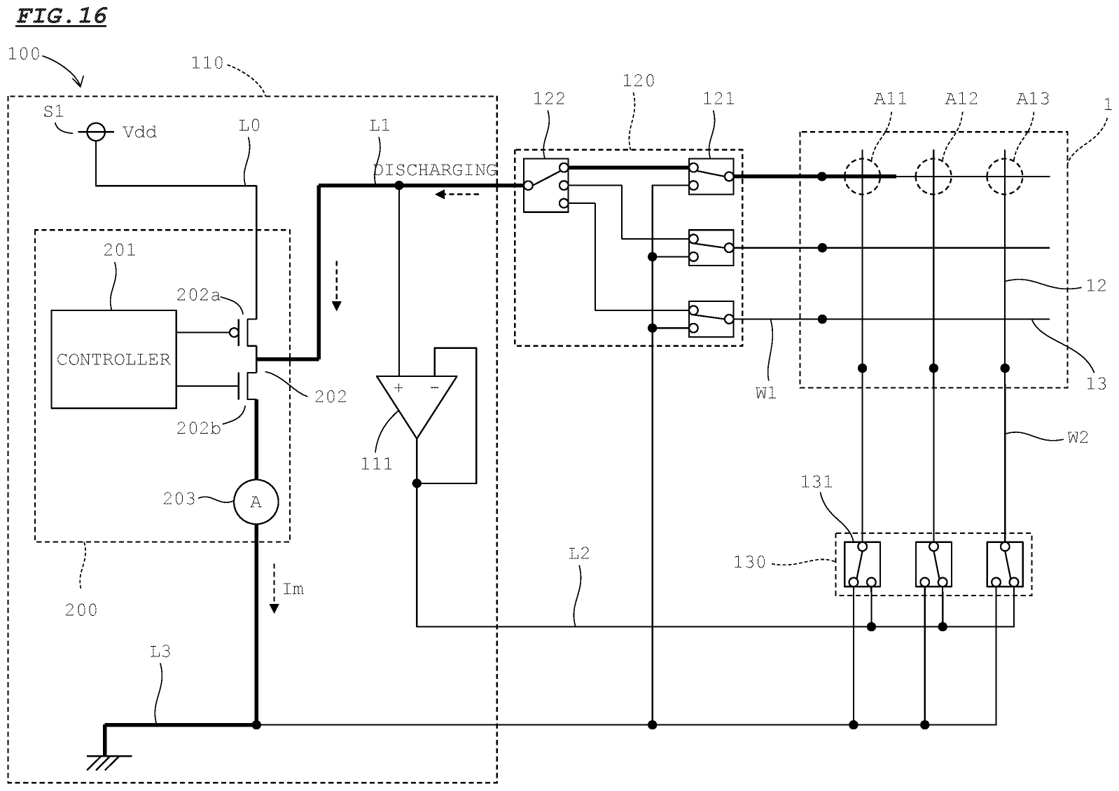

FIG. 16 shows the flow of the current when electric charge accumulated in the element part A11 is discharged.

The state of the voltage applier 100 in FIG. 16 is the same as that in FIG. 9 except for the position where the measurer 203 is disposed. When the switching element 202a is in a non-conductive state and the switching element 202b is in a conductive state, the measurer 203 measures the current that flows from the element part A11 to the ground line L3, i.e., the current Im according to the electric charge amount accumulated in the element part A11 before discharging.

In Modification 2, since the current during discharging is measured, the period Tb(n) in FIG. 7 serves as the measurement period for the current Im. In this case, with respect to the current Im, similarly to FIGS. 10A to 10D, the period from when discharging is started until the current Im becomes saturated (the period until the current Im converges to zero) changes in accordance with the load being applied to the element part A11 serving as the measurement target, i.e., the capacitance in the element part A11. Therefore, this period could become longer than the period Tb(n). Therefore, in Modification 2 as well, depending on the relationship of magnitude between the period Tb(n) and the period from when discharging is started until the current Im becomes saturated, a case where the above formula (1) is satisfied or a case where the above formula (1) is not satisfied occurs.

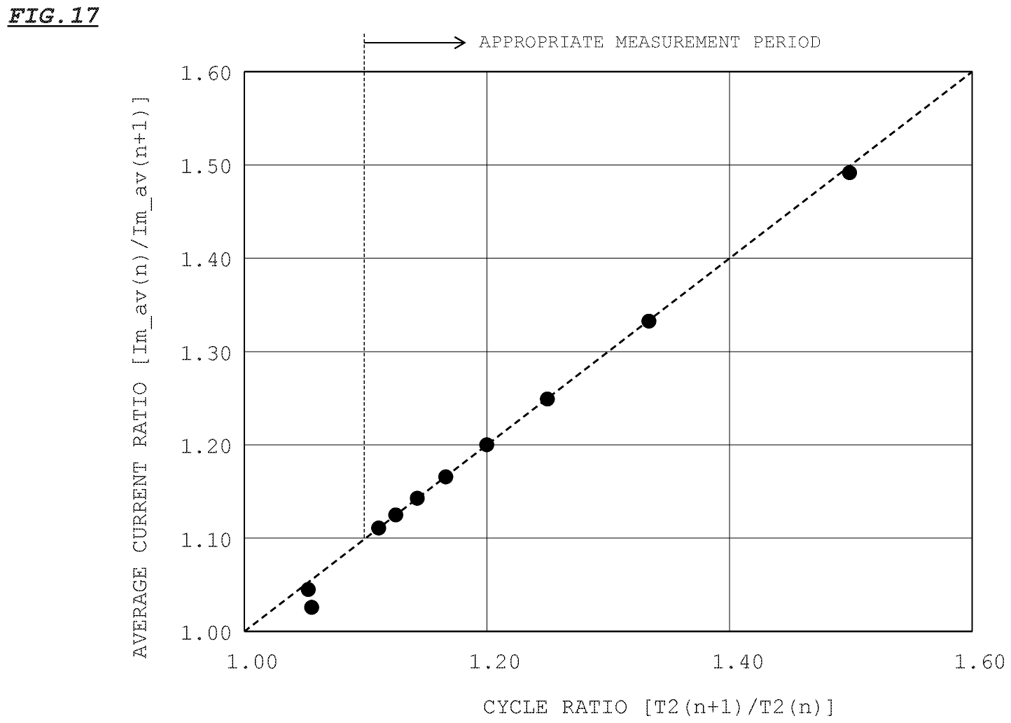

FIG. 17 is a graph showing a simulation result of a relationship, when the capacitance in an element part serving as the measurement target has a predetermined value, between: the ratio (cycle ratio) between the periods T2(n) and T2(n+1); and the ratio (average current ratio) between the average current values Im_av(n) and Im_av(n+1).

In FIG. 17, the average current values Im_av(n), Im_av(n+1) at the vertical axis are the average values of the current measured in the periods Tb(n), Tb(n+1) in FIG. 7 with respect to the periods T2(n), T2(n+1). As in the case of FIG. 11, even when the average current values Im_av(n), Im_av(n+1) are the average values of the current measured in the periods Tb(n), Tb(n+1) in FIG. 7 with respect to the periods Tb(n), Tb(n+1), a simulation result similar to that in FIG. 17 can be obtained. In addition, as in the case of FIG. 11, even when the horizontal axis represents the measurement period ratio Tb(n+1)/Tb(n), a simulation result similar to that in FIG. 17 can be obtained.

In the simulation result in FIG. 17 as well, as in FIG. 11, a range where the relationship between the cycle ratio and the average current ratio satisfies linearity and a range where said relationship does not satisfy linearity occurred. In this simulation result, in a range where the cycle ratio is smaller than 1.1, the relationship between the cycle ratio and the average current ratio did not satisfy linearity, and in a range where the cycle ratio is equal to or larger than 1.1, the relationship between the cycle ratio and the average current ratio satisfied linearity. Therefore, in Modification 2 as well, as in the above embodiment, based on whether or not the relationship between the cycle ratio and the average current ratio satisfies linearity, i.e., whether or not the relationship of the above formula (1) is satisfied, whether or not the current Im is saturated in the period Tb(n) can be determined.

Therefore, in Modification 2 as well, through the process in FIG. 12, the measurement result of the current Im when the current Im during discharging has become saturated in the period Tb(n) can be efficiently acquired and outputted to the signal processor 300.

In this case, step S12 in FIG. 12 is changed to a process of measuring the current value in the period Tb(n). In addition, in step S13 in FIG. 12, by performing the process in FIG. 13A or FIG. 13B, whether or not the current Im during discharging has become saturated in the period Tb(n) can be appropriately determined. In this case as well, instead of the determination method in FIGS. 13A, 13B, the determination method shown in FIGS. 14A, 14B may be used.

In Modification 2 as well, the capacitance in each element part can be calculated from the above formula (2). When the process in FIG. 13A is performed, the electric charge amount Qm in formula (2) is acquired by multiplying, by the period T2(n), the average current value Im_av(n)(the average current value during discharging) at the time when the determination in step S103 has become YES. When the process in FIG. 13B is performed, the total sum current value Im_sum(n)(the accumulated value of the current Im during discharging) at the time when the determination in step S112 has become YES is used as is, as the electric charge amount Om in formula (2).

As described above, in Modification 2 as well, when the period until the current Im (electric quantity) serving as the measurement target becomes saturated may change, the period Tb(n)(measurement period) for measuring the current Im (electric quantity) can be appropriately set. Therefore, a highly accurate measurement result can be efficiently acquired, and the capacitance in each element part can be appropriately detected.

### <Modification 3>

In the above embodiment, the electric quantity measured by the measurement device 200 is current. However, the electric quantity measured by the measurement device 200 may be an electric quantity other than current. In Modification 3, the electric quantity measured by the measurement device 200 is voltage.

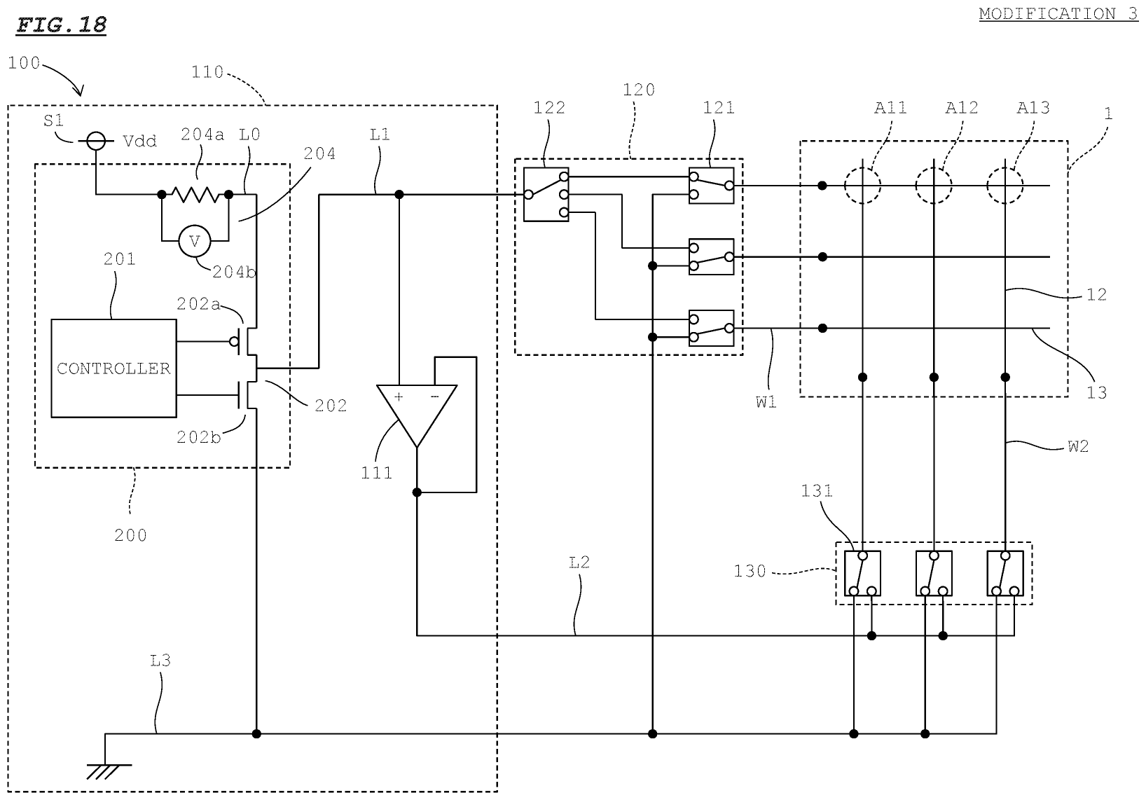

FIG. 18 shows a configuration of the measurement device 200 according to Modification 3.

As shown in FIG. 18, in Modification 3, a measurer 204 is disposed in the supply line L0. The measurer 204 includes a resistor 204a interposed in the supply line L0 and a voltmeter 204b that measures the voltage across both ends of the resistor 204a. The measurer 204 may be disposed at another position on the supply lines L0, L1. The controller 201 acquires a voltage value measured by the voltmeter 204b in the period Ta(n) in FIG. 7.

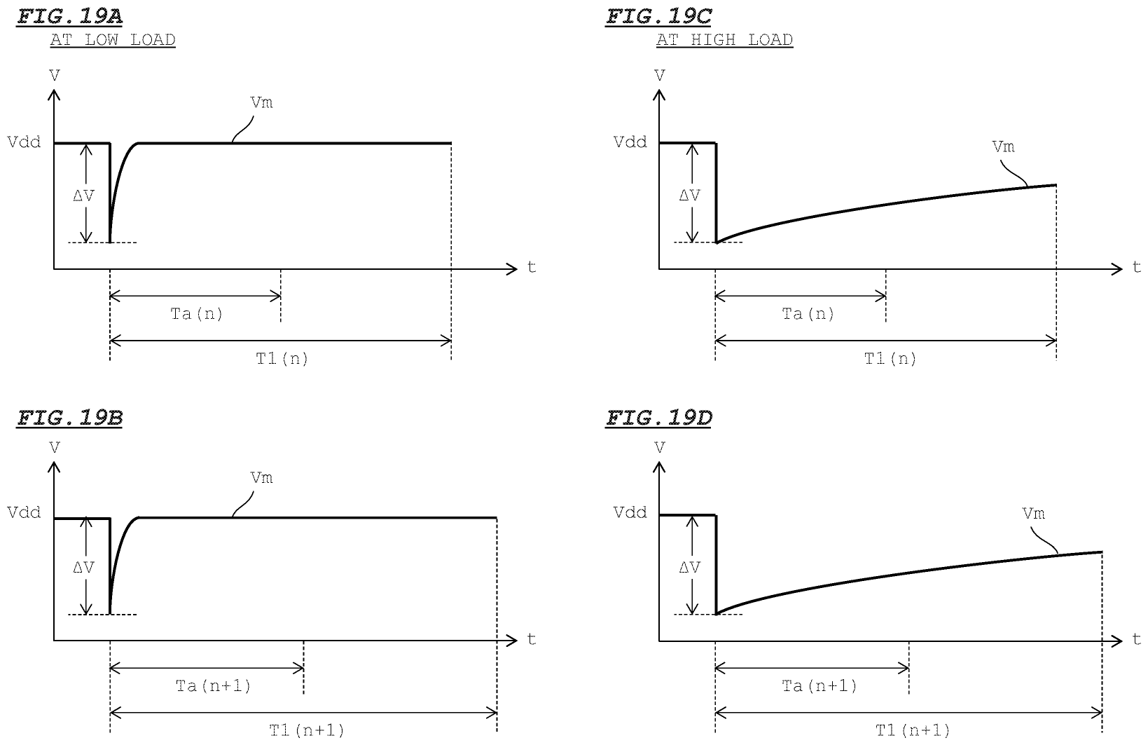

FIGS. 19A to 19D are each a graph showing a relationship between the measurement period and a voltage Vm measured by the measurer 203.

When the period Ta(n)(measurement period) has started and the switching element 202a has entered a conductive state, a voltage is applied to an element part serving as the measurement target. At this time, the voltage Vm measured by the measurer 203 drops by a certain potential from the power supply potential Vdd in accordance with start of charging to the element part due to the voltage application. Then, the voltage Vm gradually becomes close to the power supply potential Vdd in accordance with advancement of the charging to the element part serving as the measurement target. In association with this, a voltage drop ΔV of the voltage Vm gradually becomes smaller.

Here, the period from when the voltage drop ΔV has started until the voltage Vm converges to the power supply potential Vdd changes in accordance with the magnitude of the capacitance in the element part serving as the measurement target. As shown in FIGS. 19A, 19B, when the load applied to the element part serving as the measurement target is small and the capacitance in the element part is small, the period until the voltage Vm converges to the power supply potential Vdd is short. On the other hand, as shown in FIGS. 19C, 19D, when the load applied to the element part serving as the measurement target is large and the capacitance in the element part is large, the period until the voltage Vm converges to the power supply potential Vdd is long.

In the cases of FIGS. 19A, 19B, the period in which the voltage drop ΔV is occurring is shorter than the periods Ta(n), Ta(n+1). Therefore, in these cases, with respect to all the periods in which the voltage drop ΔV is occurring, the voltage drop ΔV can be measured by the voltmeter 204b. Therefore, in these cases, with respect to all the periods in which the voltage drop ΔV is occurring, the total sum (total sum voltage drop ΔV_sum(n)) of the voltage drop ΔV and the average value (average voltage drop ΔV_av(n)) of the voltage drop ΔV can be acquired.

The total sum voltage drop ΔV_sum(n) and the average voltage drop ΔV_av(n) can be calculated by the following formulas.

$$Δ V\_sum ( n ) = {\int }_{0}^{Ta ( n )} Δ Vdt \qquad ( 3 )$$

$$Δ V\_av ( n ) = \frac{Δ V\_sum ( n )}{T 1 ( n )} \qquad ( 4 )$$

In formula (4), the average voltage drop ΔV_av(n) is calculated by dividing the total sum voltage drop ΔV_sum(n) by the period T1(n). However, the average voltage drop ΔV_av(n) may be calculated by dividing the total sum voltage drop ΔV_sum(n) by the period Ta(n).

In the cases of FIGS. 19A, 19B, since the period in which the voltage drop ΔV is occurring is shorter than the periods Ta(n), Ta(n+1), the following relational expressions are satisfied.

$$Δ V\_av ( n ) / Δ V\_av ( n + 1 ) = Ta ( n + 1 ) / Ta ( n ) \qquad ( 5 )$$

$$Δ V\_sum ( n + 1 ) / Δ V\_sum ( n ) = 1 \qquad ( 6 )$$

In the cases of FIGS. 19C, 19D, the period in which the voltage drop ΔV is occurring is longer than the periods Ta(n), Ta(n+1). Therefore, in these cases, with respect to all the periods in which the voltage drop ΔV is occurring, the voltage drop ΔV cannot be measured by the voltmeter 204b. Therefore, in these cases, the above formulas (3), (4) are not satisfied. As described above, based on whether or not the period in which the voltage drop ΔV is occurring is shorter than the periods Ta(n), Ta(n+1), whether or not formulas (3), (4) can be satisfied is determined. Therefore, based on whether or not formulas (3), (4) are satisfied, whether or not the period in which the voltage drop ΔV is occurring is shorter than the periods Ta(n), Ta(n+1), i.e., whether or not the voltage Vm has become saturated within the range of the period Ta(n), Ta(n+1) and has converged to the power supply potential Vdd, can be determined.

The relationship between the change rate ΔV_av(n)/ΔV_av(n+1) of the voltage drop and the change rate Ta(n+1)/Ta(n) of the measurement period when the variable n has been changed is similar to that in FIG. 11. In the range of the variable n with which the period in which the voltage drop ΔV is occurring is shorter than the periods Ta(n), Ta(n+1), the relationship between the change rate ΔV_av(n)/ΔV_av(n+1) and the change rate Ta(n+1)/Ta(n) satisfies linearity.

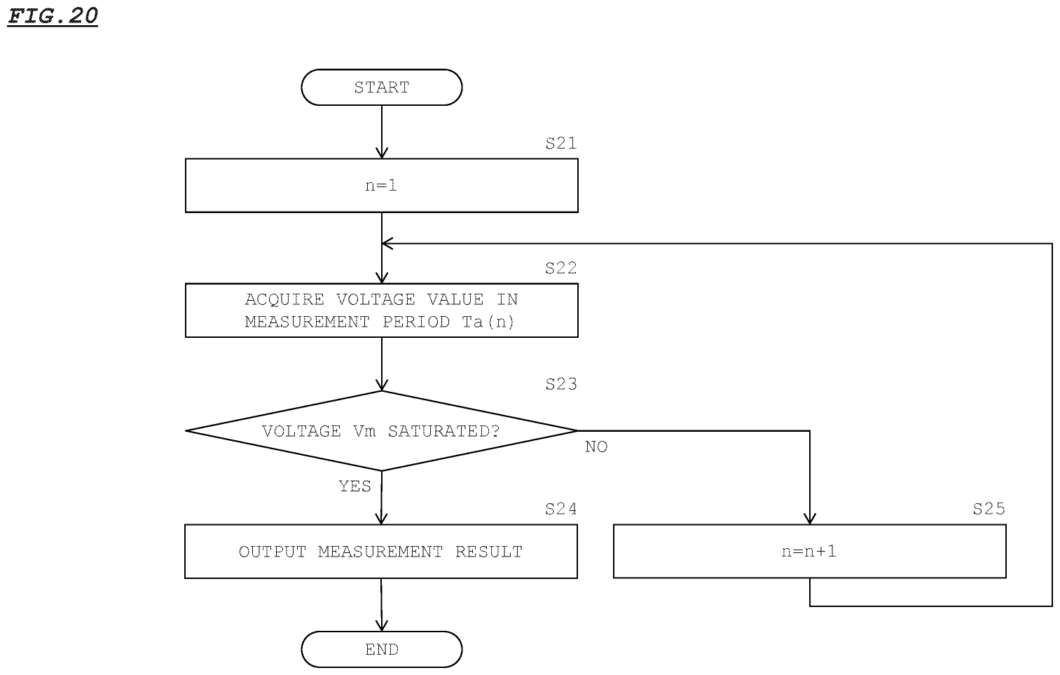

FIG. 20 is a flowchart showing a process of acquiring a measurement result of the voltage Vm with respect to an element part serving as the measurement target.

The process in FIG. 20 is basically the same as the process in FIG. 12 except that the measurement target is voltage.

When the element part serving as the measurement target is the element part A11 in FIG. 6, the first switchover part 120 and the second switchover part 130 are set to be in the state in FIG. 6 by the signal processor 300. In this state, discharging with respect to all the element parts of the load sensor 1 has been completed. Then, the controller 201 of the measurement device 200 starts output of the gate signals G1, G2 in FIG. 7 and executes the process in FIG. 20.

The controller 201 sets 1 as the variable n (S21) and acquires the measurement value of the voltage Vm in the period Ta(n) from the voltmeter 204b (S22). When the measurement of the voltage Vm in the period Ta(n) has ended, the controller 201 determines whether or not (whether or not the voltage has converged to the power supply potential Vdd) the voltage Vm has become saturated in the period Ta(n), from the acquired measurement value of the voltage Vm (S23). When the determination in step S23 is NO, the controller 201 adds 1 to the variable n (S25), and returns the process to step S22. Accordingly, the controller 201 acquires the measurement value of the voltage Vm in the next period Ta(n)(S22), and determines whether or not the voltage Vm has become saturated in the period Ta(n) from the acquired measurement value (S23).

Until the determination in step S23 becomes YES, the controller 201 executes the same process while increasing the variable n. Then, when the determination in step S23 has become YES, the controller 201 outputs the measurement result of the voltage Vm measured in the period Ta(n) at that time, to the signal processor 300, and ends outputting of the gate signals G1, G2 (S24). Accordingly, the controller 201 ends the process in FIG. 20.

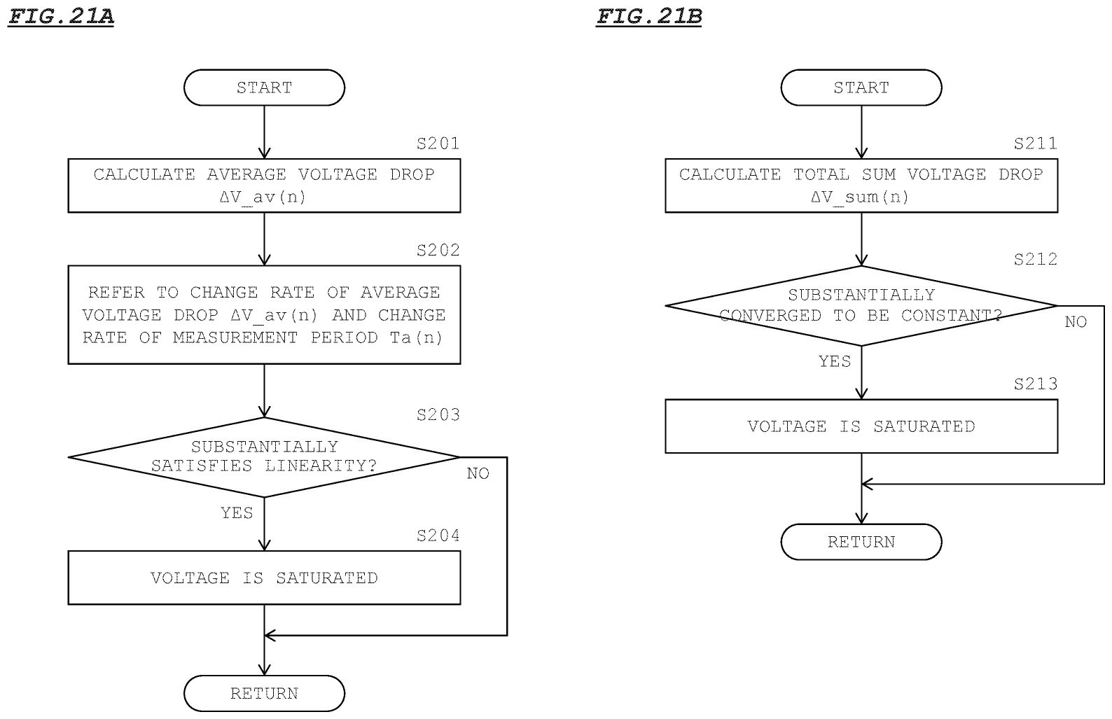

FIG. 21A is a flowchart showing the process in step S23 in FIG. 20.

The controller 201 calculates the average voltage drop ΔV_av(n) of the voltage Vm from the voltage Vm acquired in the period Ta(n)(S201). The controller 201 refers to a change rate ΔV_av(n−1)/ΔV_av(n) between an average voltage drop ΔV_av(n−1) calculated with respect to the immediately-preceding period Ta(n−1) and the average voltage drop ΔV_av(n), and a change rate Ta(n)/Ta(n−1) between the period Ta(n) and the immediately-preceding period Ta(n−1)(S202), and determines whether or not the relationship between both change rates substantially satisfies linearity (S203).

The determination in step S203 is made, as in the above formula (5), based on whether or not the change rate ΔV_av(n−1)/ΔV_av(n) and the change rate Ta(n)/Ta(n−1) are substantially equal to each other, for example, whether or not the difference between both change rates is within several %. The determination in step S203 may become YES when a fact that these two change rates are substantially equal to each other has been maintained while the variable n has been increased several times (e.g., five times). Accordingly, the fact that the voltage Vm has become saturated in the period Ta(n) can be more accurately determined.

When the determination in step S203 is YES, the controller 201 determines that the voltage has become saturated in the period Ta(n)(S204), and sets the determination in step S23 in FIG. 20 to YES. On the other hand, when the determination in step S203 is NO, the controller 201 skips step S204 and sets the determination in step S23 in FIG. 20 to NO. Accordingly, the controller 201 ends the process in FIG. 21A.

When the process in FIG. 21A is performed in step S23 in FIG. 20, the controller 201 may output, to the signal processor 300, a value obtained by multiplying, by the period T1(n), the average voltage drop ΔV_av(n) at the time when the determination in step S203 has become YES, i.e., the total sum voltage drop ΔV_sum(n), as the measurement result in step S24. In this case, the signal processor 300 calculates the electric charge amount Qm(n) accumulated in the element part A11 by the following formula.

$$Qm ( n ) = Δ V\_sum ( n ) / R \qquad ( 7 )$$

Here, R is the resistance value of the resistor 204a in FIG. 18. The signal processor 300 applies the thus calculated electric charge amount Qm to the above formula (2) to calculate the capacitance in the element part A11.

In the process in FIG. 20, as in the process in FIG. 12, the period Ta(n) that is appropriate for the element part A11 can be efficiently set, and an efficient and highly accurate measurement result can be acquired.

The process in step S23 in FIG. 20 may be the process in FIG. 21B. In this case, the controller 201 calculates the total sum voltage drop ΔV_sum(n) from the voltage value acquired in the period Ta(n)(S211), and determines whether or not the calculated total sum voltage drop ΔV_sum(n) has substantially converged to be constant (S212). In step S212, the controller 201 determines whether or not the difference between the total sum voltage drop ΔV_sum(n) calculated this time and a total sum voltage drop ΔV_sum(n−1) calculated last time is within a range of error. Alternatively, in step S212, the controller 201 determines whether or not the ratio between the total sum voltage drop ΔV_sum(n) calculated this time and the total sum voltage drop ΔV_sum(n−1) calculated last time is within a range of error having 1 at the center thereof.

In this case as well, the determination in step S212 may be set to YES when a fact that the above-described difference or ratio is within the range of error is maintained while the variable n has been increased several times (e.g., five times). Accordingly, the fact that the voltage Vm has become saturated in the period Ta(n) can be more accurately determined.

When the determination in step S212 is YES, the controller 201 determines that the voltage has become saturated in the period Ta(n)(S213), and sets the determination in step S23 in FIG. 20 to YES. On the other hand, when the determination in step S212 is NO, the controller 201 skips step S213 and sets the determination in step S23 in FIG. 20 to NO. Accordingly, the controller 201 ends the process in FIG. 21B.

In this case, the controller 201 may output, to the signal processor 300, the total sum voltage drop ΔV_sum(n) at the time when the determination in step S212 has become YES, as the measurement result in step S24. The signal processor 300 applies the acquired total sum voltage drop ΔV_sum(n) to formula (7) to calculate Qm(n), and applies the calculated Qm(n) to formula (2) to calculate the capacitance C in the element part A11.

When having acquired the capacitance with respect to the element part A11 serving as the measurement target through the process described above, the signal processor 300 sequentially switches the element part serving as the measurement target to calculate the capacitance in each element part, as in the above embodiment. When the capacitance with respect to all the element parts has been acquired, the controller 201 ends the detection process of the capacitance of this time with respect to the load sensor 1.

In Modification 3 as well, as in the above embodiment, when the period until the voltage Vm (electric quantity) serving as the measurement target becomes saturated may change, the period Ta(n)(measurement period) for measuring the voltage Vm (electric quantity) can be appropriately set. Therefore, a highly accurate measurement result can be efficiently acquired and the capacitance in each element part can be appropriately detected.

In Modification 3 as well, as in FIGS. 14A, 14B, whether or not the voltage Vm has become saturated may be determined from the relationship between the voltage Vm and a threshold Th2. In this case, the threshold Th2 is set to be slightly lower than the power supply potential Vdd. The controller 201 determines whether or not the voltage Vm has become saturated in the period Ta(n), based on whether or not a voltage value Vm E (n) of the voltage Vm measured at the end timing of the period Ta(n) is larger than the threshold Th2.

In Modification 3 as well, as in Modification 2, the voltage Vm during discharging may be detected. In this case, the measurer 204 is disposed on the path between the switching element 202b and the ground line L3, and measures the voltage at the resistor 204a disposed on this path, in the period Tb(n) in FIG. 7. In this case as well, through processes similar to those in FIG. 20 and FIGS. 21A, 21B, a measurement result with respect to the voltage Vm during discharging can be acquired.

### <Other Modifications>

In the above embodiment, the period Ta(n) is set such that the period Ta(n) serving as the measurement period becomes longer in association with increase in the variable (n). However, the method of setting the period Ta(n) is not limited thereto. For example, with respect to the first element part A11, an appropriate period Ta(n) may be set through the same process as that described above, and with respect to the next element part A12, an appropriate period Ta(n) may be searched for, while the length of the period Ta(n) is changed in the long-short direction, with the appropriate period Ta(n) at the time when the determination in step S13 in FIG. 12 has become YES in the first element part A11 used as the center. With respect to the element parts thereafter, similarly, an appropriate period Ta(n) may be searched for, while the length of the period Ta(n) is changed in the long-short direction, with the period Ta(n) determined to be appropriate with respect to the immediately-preceding element part used as the center. Similar changes can be applied to Modifications 2,3 as well.

The number (the number of kinds) of the measurement periods used in measurement of the current amount may be set to a number that allows efficient determination of the fact the current amount has become saturated.

In the above embodiment, the electric charge amount Qm is calculated by multiplying the average current value Im_av(n) by the period T1(n). However, the method of obtaining the electric charge amount Qm is not limited thereto. For example, when the average current value Im_av(n) is calculated with respect to the period Ta(n), the electric charge amount Qm may be calculated by multiplying the average current value Im_av(n) by the period Ta(n). Alternatively, instead of multiplication by the period T1(n), the average current value Im_av(n) may be divided by a frequency F1(n) corresponding to the period T1(n), to calculate the electric charge amount Qm. Alternatively, the current Im may be accumulated during the period Ta(n), to acquire the electric charge amount Qm.

In the above embodiment, the first switchover part 120 and the second switchover part 130 are implemented by the multiplexers 121, 122, 131. However, the first switchover part 120 and the second switchover part 130 may be implemented by a switchover circuit other than the multiplexer.

In the above embodiment, in the first switchover part 120, the multiplexer 122 is disposed in the preceding stage of the three multiplexers 121. However, the multiplexer 122 may be omitted and the supply line L1 may be directly connected to one input terminal of each of the three multiplexers 121.

In the above embodiment, nine element parts are disposed in a matrix shape to form the load sensor 1. However, the configuration of the load sensor 1 is not limited thereto. For example, the load sensor 1 may be formed by a plurality of element parts being arranged only in one row, or the load sensor 1 may have only one element part. In this case as well, the processes in the above embodiment and Modifications 1 to 3 may be applied to each element part.

In the above embodiment, the switchover part 202 has two switching elements 202a, 202b. However, the switchover part 202 may have another configuration as long as the supply line L1 can be selectively connected to the supply line L0 and the ground line L3. For example, as the switchover part 202, a multiplexer similar to the multiplexer 121 may be used. In this case as well, the controller 201 may control the multiplexer such that: the period Ta(n) for charging and the period Tb(n) for discharging shown in FIG. 7 alternately occur; and the lengths of the period Ta(n) and the period Tb(n) become longer in association with increase in the variable n.

In the above embodiment, the conductor wire 13 is implemented by a covered copper wire, but not limited thereto, may be composed of a linear-shaped electrically-conductive member formed from a substance other than copper and a dielectric body covering the electrically-conductive member. The electrically-conductive member may be implemented by a twisted wire.

In the above embodiment, the electrically-conductive elastic bodies 12 are provided only on the face on the Z-axis positive side of the base member 11. However, electrically-conductive elastic bodies may be provided also on the face on the Z-axis negative side of the base member 15. In this case, the electrically-conductive elastic bodies on the base member 15 side are configured similarly to the electrically-conductive elastic bodies 12 on the base member 11 side, and are disposed so as to overlap the electrically-conductive elastic bodies 12 so as to sandwich the conductor wires 13 in a plan view. Then, the cables drawn from the electrically-conductive elastic bodies on the base member 15 side are connected to the wiring cable W2 drawn from the electrically-conductive elastic bodies 12 opposed in the Z-axis direction. When the electrically-conductive elastic bodies are provided above and below the conductor wires 13 in this manner, change in the capacitance in each element part becomes approximately twice correspondingly to the upper and lower electrically-conductive elastic bodies. Therefore, the detection sensitivity of the load applied to the element part can be enhanced.

In the above embodiment, the dielectric body 13b is formed on the electrically-conductive member 13a so as to cover the outer periphery of the electrically-conductive member 13a. However, instead of this, the dielectric body 13b may be formed on the upper face of the electrically-conductive elastic body 12. In this case, in accordance with application of the load, the electrically-conductive member 13a sinks so as to be wrapped by the dielectric body 13b and the electrically-conductive elastic body 12, and the contact area between the electrically-conductive member 13a and the electrically-conductive elastic body 12 changes. Accordingly, similar to the above embodiment, the load applied to the element part can be detected.

In the above embodiment, the element part is formed by the electrically-conductive elastic body 12 and the conductor wire 13 crossing each other. However, the configuration of the element part is not limited thereto. For example, the element part may be formed by a hemisphere-shaped electrically-conductive elastic body and a flat-plate-shaped electrode sandwiching a dielectric body. In this case, the dielectric body may be formed on the surface of the electrode opposing the electrically-conductive elastic body, or may be formed on the surface of the hemisphere-shaped electrically-conductive elastic body.

In addition, the measurement device according to the present invention can be used as appropriate not only in the load sensor but also in another circuit in which the electric quantity serving as the detection target changes to be saturated such as a ceramic capacitor, an electrolytic capacitor, or a capacitive element formed in a semiconductor device or an electrostatic touch panel.

In addition to the above, various modifications can be made as appropriate to the embodiment of the present invention without departing from the scope of the technical idea defined by the claims.

### (Additional Note)

The following technologies are disclosed by the description of the embodiment above.

### (Technology 1)

A measurement device comprising:
a switchover part configured to switch application and non-application of a voltage to an electric circuit;
a measurer configured to measure an electric quantity in a predetermined portion in the electric circuit; and
a controller configured to control the switchover part and the measurer to measure the electric quantity that changes to be saturated in the predetermined portion, wherein
the controller
   sets a plurality of measurement periods different from each other,
   starts application of the voltage in synchronization with start of each of the measurement periods,
   determines whether or not the electric quantity measured by the measurer in each of the measurement periods has become saturated, and
   acquires a measurement result of the electric quantity with respect to the measurement period for which it has been determined that the electric quantity has become saturated.

According to this technology, among a plurality of measurement periods different from each other, with respect to the measurement period for which it has been determined that the electric quantity serving as the measurement target has become saturated, a measurement result of the electric quantity is acquired. Therefore, even when the period until the electric quantity serving as the measurement target becomes saturated may change, the measurement period for the electric quantity can be appropriately set, and a highly accurate measurement result can be efficiently acquired.

### (Technology 2)

The measurement device according to technology 1, wherein
the controller
   sequentially changes lengths of the plurality of measurement periods in one direction,
   calculates an average value of the electric quantity in each of the measurement periods, and
   determines whether or not the electric quantity has become saturated, based on whether or not a relationship between a change rate of the measurement period and a change rate of the average value substantially satisfies linearity.

According to this technology, whether or not the electric quantity has become saturated in the measurement period can be accurately determined.

### (Technology 3)

The measurement device according to technology 1, wherein
the controller
   sequentially changes lengths of the plurality of measurement periods in one direction, and
   determines whether or not the electric quantity has become saturated, based on whether or not a total sum of the electric quantity acquired in each of the measurement periods has substantially converged to be constant in the measurement period.

According to this technology, as in technology 2, whether or not the electric quantity has become saturated in the measurement period can be appropriately determined.

### (Technology 4)

The measurement device according to technology 2 or 3, wherein
the controller sequentially increases the lengths of the plurality of measurement periods.

According to this technology, the length of the measurement period can be gradually made close to the length at which the electric quantity is saturated. Therefore, an appropriate measurement period can be smoothly set.

### (Technology 5)

The measurement device according to any one of technologies 1 to 4, wherein
the electric quantity is current.

According to this technology, through the above process, a measurement period according to change in current can be appropriately set.

### (Technology 6)

The measurement device according to any one of technologies 1 to 4, wherein
the electric quantity is voltage.

According to this technology, through the above process, a measurement period according to change in voltage can be appropriately set.

### (Technology 7)

A load detection system comprising:
a load sensor including an element part in which capacitance changes in accordance with a load;
a voltage applier including the measurement device according to any one of technologies 1 to 6 and configured to apply a voltage to the element part; and
a signal processor configured to acquire the capacitance in the element part from a measurement result obtained by the measurement device, wherein
the measurement device
   applies the voltage to the element part through the switchover part,
   measures an electric quantity in a predetermined portion of the voltage applier through the measurer, and
   outputs a measurement result of the electric quantity acquired by the controller, to the signal processor.

According to this technology, since the measurement device according to any one of technologies 1 to 6 is used, even when the capacitance in the element part changes in accordance with the load, a measurement period according to the capacitance can be set. Therefore, the electric quantity according to the capacitance can be efficiently and accurately measured, and the load in the element part can be accurately detected.

### (Technology 8)

The load detection system according to technology 7, wherein
the load sensor includes a plurality of the element parts,
the voltage applier is configured to be able to switch the element part to which the voltage is applied, and
the signal processor controls the voltage applier to apply the voltage to each of the element parts, acquires the measurement result with respect to each of the element parts from the measurement device, and acquires the capacitance in each of the element parts from the acquired measurement result.

According to this technology, since a plurality of the element parts are disposed, the load detection range can be widened. Since the above process is executed with respect to each of the element parts, the capacitance applied to each of the element parts can be accurately detected, and the load in each of the element parts can be efficiently detected.

### (Technology 9)

The load detection system according to technology 8, wherein
the plurality of element parts are disposed in a matrix shape so as to be arranged in a plurality of rows and a plurality of columns,
the element parts in the row that is identical each have one electrode thereof connected to each other,
the element parts in the column that is identical have another electrode thereof connected to each other, and
the voltage applier includes a switching element configured to switch the row and the column to which the voltage is applied.

According to this technology, since a plurality of the element parts are disposed in a matrix shape, distribution of the load in an area spreading in a quadrangular shape can be detected by these element parts. In addition, since the row and the column to which potentials are applied are switched by the switching element, predetermined potentials can be respectively applied to two electrodes of the element part present at the crossing position of the row and the column after the switching, and the capacitance in the element part can be efficiently detected through the above control.

What is claimed is:

1. A measurement device comprising:
a switchover part configured to switch application and non-application of a voltage to an electric circuit;
a measurer configured to measure an electric quantity in a predetermined portion in the electric circuit; and
a controller configured to control the switchover part and the measurer to measure the electric quantity that changes to be saturated in the predetermined portion, wherein
the controller
sets a plurality of measurement periods different from each other,
starts application of the voltage in synchronization with start of each of the measurement periods,
determines whether or not the electric quantity measured by the measurer in each of the measurement periods has become saturated, and
acquires a measurement result of the electric quantity with respect to the measurement period for which it has been determined that the electric quantity has become saturated.

2. The measurement device according to claim 1, wherein
the controller
sequentially changes lengths of the plurality of measurement periods in one direction,
calculates an average value of the electric quantity in each of the measurement periods, and
determines whether or not the electric quantity has become saturated, based on whether or not a relationship between a change rate of the measurement period and a change rate of the average value substantially satisfies linearity.

3. The measurement device according to claim 1, wherein
the controller
sequentially changes lengths of the plurality of measurement periods in one direction, and
determines whether or not the electric quantity has become saturated, based on whether or not a total sum of the electric quantity acquired in each of the measurement periods has substantially converged to be constant in the measurement period.

4. The measurement device according to claim 2, wherein
the controller sequentially increases the lengths of the plurality of measurement periods.

5. The measurement device according to claim 1, wherein
the electric quantity is current.

6. The measurement device according to claim 1, wherein
the electric quantity is voltage.

7. A load detection system comprising:
a load sensor including an element part in which capacitance changes in accordance with a load;
a voltage applier including the measurement device according to claim 1 and configured to apply a voltage to the element part; and
a signal processor configured to acquire the capacitance in the element part from a measurement result obtained by the measurement device, wherein
the measurement device
applies the voltage to the element part through the switchover part,
measures an electric quantity in a predetermined portion of the voltage applier through the measurer, and
outputs a measurement result of the electric quantity acquired by the controller, to the signal processor.

8. The load detection system according to claim 7, wherein
the load sensor includes a plurality of the element parts,
the voltage applier is configured to be able to switch the element part to which the voltage is applied, and
the signal processor controls the voltage applier to apply the voltage to each of the element parts, acquires the measurement result with respect to each of the element parts from the measurement device, and acquires the capacitance in each of the element parts from the acquired measurement result.

9. The load detection system according to claim 8, wherein
the plurality of element parts are disposed in a matrix shape so as to be arranged in a plurality of rows and a plurality of columns,
the element parts in the row that is identical each have one electrode thereof connected to each other,
the element parts in the column that is identical have another electrode thereof connected to each other, and
the voltage applier includes a switching element configured to switch the row and the column to which the voltage is applied.
